(19) United States
(12) Patent Application Publication
(10) Pub. No.: US 2026/0065549 A1
(43) Pub. Date: Mar. 5, 2026

(54) Generation of Interactive Data Visualizations and Textual Content

(71) Applicant: Salesforce, Inc., San Francisco, CA (US)

(72) Inventors: Maxim LISNIC, Seattle, WA (US); Vidya Raghavan SETLUR, Portola Valley, CA (US); Nicole Barbosa SULTANUM, Seattle, WA (US)

(21) Appl. No.: 19/026,340

(22) Filed: Jan. 16, 2025

Related U.S. Application Data
(60) Provisional application No. 63/691,298, filed on Sep. 5, 2024.
(60) Provisional application No. 63/694,174, filed on Sep. 12, 2024.

(51) Int. Cl. G06T 11/60; G06T 11/20

(52) U.S. Cl. CPC G06T 11/60; G06T 11/26; G06T 2200/24

(57) ABSTRACT

A system can be used to generate interactive data visualizations and textual content. The system receives a layout of a content item. The content item can be a data visualization dashboard or an article. The system can generate a content structure tree based on the layout. The content structure tree represents hierarchical and semantic relationships between sections of the content item. The system can receive input adding content elements, such as data visualizations or textual paragraphs, to sections within the content item. The system can identify text roles for different sections based on the content structure tree and the content elements. The system can generate text suggestions for the content item based on the text roles. The system can also generate text content for a text suggestion using a large language model, display the generated text content within the content item, and iteratively refine the content item.

### RELATED APPLICATIONS

This application claims priority to U.S. Provisional Application Ser. No. 63/691,298, filed Sep. 5, 2024, entitled “Generation of Interactive Data Visualizations and Textual Content,” and U.S. Provisional Application Ser. No. 63/694,174, filed Sep. 12, 2024, entitled “Plume: Scaffolding Text Composition in Dashboards,” each of which is incorporated by reference herein in its entirety.

### TECHNICAL FIELD

The disclosed implementations relate generally to data visualization and more specifically to systems and methods for generating text for visualizations and contents of dashboards using generative artificial intelligence.

### BACKGROUND

Dashboards have become a ubiquitous tool in data analysis and reporting, widely used across various industries to present and interpret data visually. Dashboards help users quickly grasp complex information through charts, graphs, and other visual elements. While visual components are vital to dashboards, the accompanying text plays an important role in providing context, explanations, and insights complementing the visuals. Integrating text in dashboards is crucial for enhancing user comprehension and interaction, serving as both instructional and interpretive elements. Text plays functional and semantic roles in interactive dashboards. Text not only guides users in understanding visualizations but also facilitates insight extraction.

Text can play diverse roles from simple labels to complex narrative elements that provide context and interpretation. Text is used in various types of dashboards to achieve specific design goals, such as enhancing readability and guiding user interaction. Text is important in broadening the scope of dashboard use, for supporting dashboard functionality and user engagement. Text is important in facilitating collaborative decision-making. Well-integrated text can enhance the usability of dashboards by providing clear and concise information that supports group discussions and consensus-building. The balance between text and charts is important to dashboard design. Integrated text and charts can help balance immediate data comprehension and deeper narrative exploration. It is also important to strategically place text to complement visual elements without overwhelming users.

Despite text being an indispensable component of visualization dashboards, conventional visualization and dashboard tools lack features to aid authors in composing text. This deficiency stands out when compared to the robust support available for creating visualizations. When designing charts, authors benefit from systems that provide reasonable defaults, a variety of common chart options, and guidance on good visual communication practices. No similar assistance exists for text composition despite the tedious nature of composing or updating text in dashboards.

### SUMMARY

Accordingly, there is a need for systems and methods to aid authors in composing text for their visualizations and articles. The present disclosure describes systems, methods and interfaces for generating interactive data visualizations and textual content, which may be used by authors for composing text for their dashboards or articles. Some implementations use text composition for visualizations and the contents of the dashboard to scaffold and automatically generate text (e.g., dashboard text) with generative artificial intelligence (AI), such as large language models. Some implementations provide templated text generation, rule-based and expert systems, and/or stochastic text generation using Markov chains. Some implementations use information contained in a layout for a dashboard or an article, underlying data, and/or visualization specifications, to recommend defaults for text.

Some implementations support organization and reading order, provide guidance for meaningful placement and easy-to-read composition of text, and/or offer functionality to automatically generate text for the entire dashboard. Some implementations offer text suggestions based on guidelines for effective dashboard text and/or generate text using large language models. In some implementations, the system interface utilizes visually salient frames to clarify text scope for authors. Some implementations ensure meaningful placement of text generated by the system. In some implementations, users can compose text by manually typing it, accepting and editing placeholders with suggestions, and/or simply letting the system automatically generate text. Some implementations surface common types of dashboard text and relationships between dashboard content, enabling authors to produce contextually appropriate and easy-to-follow text. In some implementations, the system translates the visual dashboard composition to the semantic dependencies between its text. While placing and generating text, the system infers how pieces of text in different subsections of a dashboard or an article relate to each other by considering the layout.

According to some implementations, a method is provided for generating dashboard text. The method is performed at a computing device having one or more processors, and memory storing one or more programs configured for execution by the one or more processors. The method includes receiving a layout of a content item, such as a data visualization dashboard or an article. The method includes generating a content structure tree based on the layout. The content structure tree represents hierarchical and semantic relationships between sections of the content item. The method also includes receiving input adding one or more content elements to sections within the content item. The content elements may include data visualizations for a dashboard or textual paragraphs for an article. The method also includes identifying text roles for different sections of the content item based on the content structure tree and the one or more content elements. The method also includes generating text suggestions for the content item based on the identified text roles. The method includes receiving input selecting at least one of the text suggestions. The method also includes generating text content for a selected text suggestion using a large language model. The method also includes displaying the generated text content within the content item. The method also includes iteratively refining the content item based on user feedback and content updates.

In some implementations, generating the content structure tree includes identifying parent-child relationships between content sections based on structural nesting and semantic relationships in the layout, assigning a hierarchical level to each identified section, and creating nodes in the content structure tree corresponding to each section, with edges representing the identified relationships.

In some implementations, generating the content structure tree includes performing grid-based parsing of the layout to identify spatial arrangement of elements, analyzing proximity and containment relationships between the elements to determine parent-child relationships, performing semantic analysis to classify each element based on its type and role in the content item, assigning roles to text elements based on their relationship with visual components, establishing hierarchical dependencies between nodes based on spatial and semantic analysis, and dynamically updating the content structure tree in response to user changes to the layout.

In some implementations, identifying text roles and generating text suggestions includes analyzing the content structure tree to identify appropriate locations for different text roles, examining specifications and data of content elements within each section, to identify content type for each content element, and determining appropriate text roles for each content element based on (i) the content type, (ii) position of the content element in the content structure tree, and (iii) comparing a current structure for the content element to predefined templates and best practices.

In some implementations, the text roles include at least one of: context, insight, data label, interaction explanation, metadata, metric explanation, or visual encoding explanation.

In some implementations, iteratively refining the content item includes monitoring user interactions with the content item, detecting changes in underlying data or textual content for the content item, updating the content structure tree in response to user modifications to the layout, regenerating text content based on the updated content structure tree and content changes, and dynamically adjusting text placement and roles within the content item to maintain semantic coherence with the updated content structure tree and content.

In some implementations, generating text content using the large language model includes identifying relevant context for the selected text suggestion based on its position in the content structure tree and its text role, retrieving specifications of related content elements, including data types, encodings, key topics, and named entities, incorporating any user-entered text in the content item, selecting similar text from a database of exemplary content items based on structural and content similarity, and inputting the identified context, specifications, user-entered text, and similar text as a prompt to the large language model to obtain the text content.

In some implementations, the method further includes enforcing an asynchronous order of text generation based on the content structure tree. The text in leaf sections of the content structure tree is generated before text in parent sections, and text in a parent section summarizes or compares text from its child sections.

In some implementations, the method further includes maintaining semantic coherence by analyzing relationships between text elements across different levels of hierarchy of the content tree structure, ensuring consistency in terminology, tone, and narrative flow, adjusting generated text to align with user-defined content objectives and inferred intent, based on analysis of locked-in text, and resolving conflicts between automatically generated text and user-entered content.

In some implementations, the method further includes providing snippet-level guidance for user-entered text, including recommendations for writing text based on the identified text role, text metrics including at least one of word count, word variety, or readability score, and options to regenerate, shorten, simplify, or modify text style using the large language model.

In some implementations, the method further includes analyzing the semantics of the data or textual content, including trends, key topics, and named entities, and incorporating semantic analysis into the text generation process to provide insights or summaries.

In some implementations, the method further includes analyzing user interactions to identify areas of user interest or confusion by tracking user engagement patterns, including tracking frequency and duration of user interactions with specific dashboard elements, identifying sections of the content item with high or low engagement, detecting repeated interactions that may indicate confusion, comparing interaction patterns against expected flows based on the content structure tree, and generating targeted suggestions for improving clarity or usability based on the areas of user interest or confusion.

In some implementations, the method further includes monitoring changes in underlying data or textual content, automatically updating the generated text content when significant changes are detected, and providing one or more alerts to the user when automatic updates affect an overall narrative or message of the content item.

In some implementations, significant changes are determined by calculating statistical measures of change in key metrics or content, identifying shifts in trends, patterns, or key topics, detecting appearance or disappearance of important data categories or named entities, and comparing changes against predefined thresholds specific to the content type.

In some implementations, the one or more alerts is selected from the group consisting of notifications of newly emerging trends or topics that contradict previous insights, warnings about significant changes in key metrics or facts highlighted in summaries, suggestions to review and potentially update high-level conclusions or headlines, and indications of sections where generated text no longer accurately reflect the updated content.

In some implementations, providing the one or more alerts includes categorizing significance of detected changes based on their potential impact on key insights or conclusions, generating different levels of alerts based on the categorized significance, providing interactive previews of how the changes might affect a dashboard's narrative, providing options to accept, modify, or reject suggested updates, and maintaining a log of significant changes and user decisions for future reference and analysis.

In some implementations, the method further includes using locked-in text to infer content intent and tone, by (i) analyzing the content and style of user-entered text, (ii) identifying key themes, terminology, and narrative elements, and (iii) extracting sentiment and formality levels, and using the inferred content intent and tone to guide the generation of new text content.

In some implementations, using locked-in text to infer content intent and tone further includes performing linguistic analysis on the locked-in text to identify key phrases, sentiments, and writing style, creating a user intent profile based on comparing the identified key phrases, sentiments, and writing style with a database of industry-specific communication styles, and using the user intent profile to guide the generation and refinement of new text content across the dashboard.

In some implementations, the method further includes providing real-time feedback on content readability and coherence by calculating readability scores for individual text elements and the content item as a whole, analyzing logical flow of information across content sections, identifying potential inconsistencies or contradictions in presented data, facts, or arguments and evaluating balance of different content elements, and suggesting improvements based on the readability scores, the logical flow, the potential inconsistencies or contradictions, and best practices for the content type and identified text roles, to improve readability while maintaining intended message and tone.

In some implementations, providing real-time feedback on content readability and coherence further includes calculating Flesch-Kincaid readability score for the individual text elements and the content item as a whole, comparing the calculated scores against predefined thresholds based on intended audience, monitoring word variety for the individual text elements and the content item as a whole, to avoid redundancy and maintain engagement, determining appropriate word count for the individual text elements and the content item as a whole, based on text role, analyzing the logical flow between text elements to ensure alignment with overall narrative structure, and considering the hierarchical relationships within the dashboard to maintain consistent tone and intent across different sections.

In some implementations, the method further includes matching a current structure of a content against a library of predefined templates and exemplary dashboards for type of the respective content type, identifying potential improvements in layout, content organization, or narrative flow, suggesting additions of commonly used elements that are currently missing, and providing guidance on industry-specific best practices relevant to the content's purpose and audience.

In some implementations, the method further includes maintaining a database of exemplary dashboards curated from industry best practices, analyzing a current dashboard layout and content to identify its primary purpose and industry context, selecting relevant exemplary dashboards based on the identified purpose and context, comparing the current dashboard against the selected exemplary dashboards to identify potential improvements, and generating suggestions for enhancements in layout, content organization, and narrative flow based on the comparison.

In some implementations, the method further includes determining missing elements in the dashboard by (i) analyzing the dashboard's layout, content, and relationships between visualizations and text, (ii) identifying gaps where essential text or visual elements may be missing, and (iii) prioritizing suggestions for adding missing elements based on their importance to overall narrative and user comprehension, and providing the suggestions that align with intent to enhance clarity and effectiveness of the dashboard, based on the missing elements.

In some implementations, the method further includes differentiating between structural positioning and text roles in the content structure tree, allowing text to be moved between different sections while maintaining its text role, and updating the text content and context based on the text's new position in the content structure tree when moved.

In some implementations, the method further includes applying custom styling based on text roles, including adjusting font sizes, styles, and colors based on importance and function of each text role, and modifying tone and emphasis to match semantic levels and roles of the text.

In some implementations, the content structure tree is generated based on user input defining the layout, importing a pre-authored template or existing content item, or a combination of user authoring and pre-defined templates.

In some implementations, the method further includes maintaining visual containment relationships by analyzing spatial arrangement and hierarchical structure of dashboard elements, identifying visual and structural cues including proximity, alignment, and grouping of elements, creating visually salient frames that enclose related content, and ensuring that each text and visualization is placed within an appropriate frame to define its scope.

In some implementations, the method further includes determining relevance of text examples for generating text suggestions analyzing role of text to be generated, considering type of visualization and data context, examining specific attributes of data and its visual representation, evaluating position of the text within the dashboard's hierarchical structure, and taking into account user preferences and overall dashboard context.

In another aspect, a computer system for generating interactive data visualizations and textual content includes one or more processors and memory. The memory stores one or more programs configured for execution by the one or more processors, and the one or more programs include instructions to perform any of the methods described herein.

In another aspect, a non-transitory computer readable storage medium stores one or more programs configured for execution by a computer system having a display, one or more processors, and memory. The one or more programs include instructions to perform any of the methods described herein.

Both the foregoing general description and the following detailed description are exemplary and explanatory and are intended to provide further explanation of the invention as claimed.

### BRIEF DESCRIPTION OF THE DRAWINGS

For a better understanding of the aforementioned systems, methods, and graphical user interfaces, as well as additional systems, methods, and graphical user interfaces that provide data visualization analytics, reference should be made to the Description of Implementations below, in conjunction with the following drawings in which like reference numerals refer to corresponding parts throughout the figures.

FIG. 1 shows an example graphical user interface for generating interactive data visualizations and textual content, according to some implementations.

FIG. 2A is an example view of the graphical user interface of FIG. 1, according to some implementations.

FIG. 2B shows Table 1 listing global guidance suggestions in one implementation based on snippet text roles, according to some implementations.

FIG. 3 shows an example graphical user interface for generating interactive data visualizations and textual content, in accordance with some implementations.

FIGS. 4A-4C shows an illustration of the text generation logic of a section title with respect to the dashboard dependency tree, according to some implementations.

FIG. 4D shows an illustration of an example usage scenario, according to some implementations.

FIG. 5A illustrates a codebook that is used to code all text snippets, according to some implementations.

FIGS. 5B-5D illustrate example dashboards, according to some implementations.

FIGS. 6A-16 illustrate an example process for generating dashboard text, according to some implementations.

FIG. 17 is a block diagram of an example computing device for generating and/or displaying interactive data visualizations and textual content, according to some implementations.

FIG. 18 is a flowchart of an example method for generating dashboard text according to some implementations.

Reference will now be made to implementations, examples of which are illustrated in the accompanying drawings. In the following description, numerous specific details are set forth in order to provide a thorough understanding of the present invention. However, it will be apparent to one of ordinary skill in the art that the present invention may be practiced without requiring these specific details.

### DESCRIPTION OF IMPLEMENTATIONS

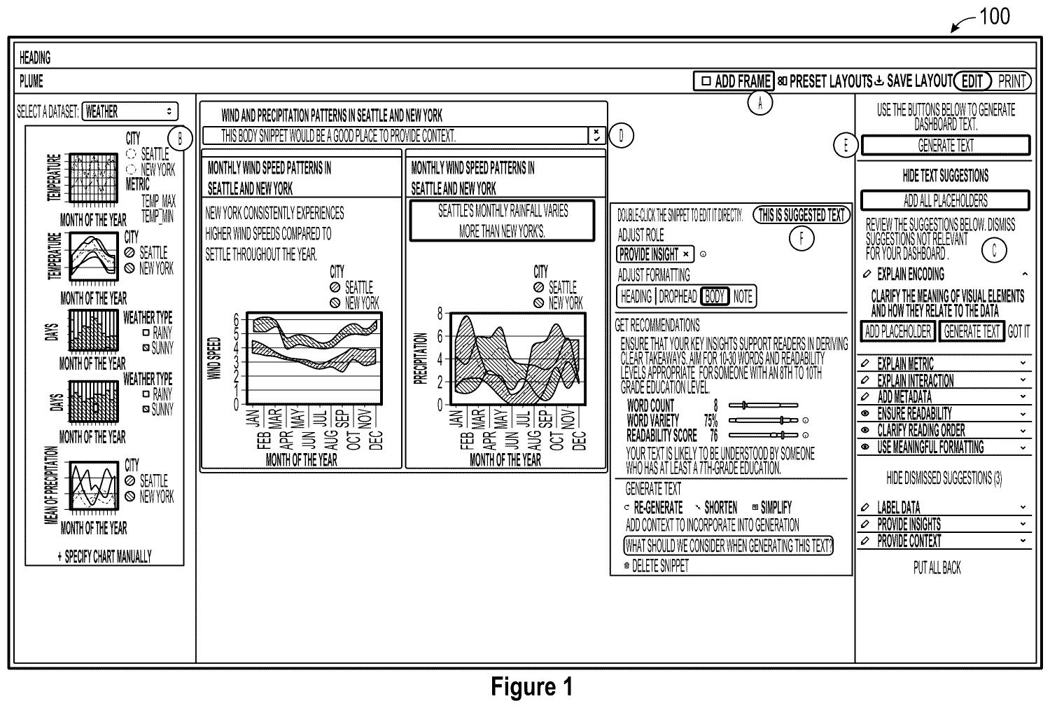

FIG. 1 shows an example graphical user interface 100 for generating interactive data visualizations and textual content, according to some implementations. A user starts by adding frames to canvas (A), dragging in charts from the charts drawer (B), and then editing text by following text suggestions in the sidebar (C). The user further modifies the dashboard by dragging and resizing frames in the canvas. FIG. 1 shows example modes of authoring text: accepting a system-suggested placeholder and typing text manually (D), and asking the system to generate text based on the dashboard automatically using LLMs by pressing the generation button (E). The user can also click into a text fragment to reveal a dropdown menu (F) with guidance on how to compose effective text, linguistic metrics of readability, and options to regenerate or refine the text using LLMs. In some implementations, text in a dashboard plays critical roles, such as providing context, offering insights, guiding interactions, and summarizing key information. The system presented herein assists users to craft effective dashboard text. In some implementations, the system presented herein is based on a typology of text parameters and a relationship between visual placement and semantic connections. In particular, the system implements LLMs to generate contextually appropriate content and provides guidelines for crafting clear, readable text.

In some implementations, the system generates and uses a content tree structure. The content tree structure (sometimes referred to as a dashboard frame tree, a dashboard tree, a dashboard dependency tree, or a scope dependency tree) represents dependence relationships between each subsection of a dashboard or an article as a tree structure. Some implementations use the dashboard tree for surfacing a coherent reading order for the author, offering suggestions for meaningful placement of text in the dashboard, and/or identifying relevant context for generating new text using large language models (LLMs).

In some implementations, the content tree structure is generated from the dashboard layout through a systematic analysis of the visual and semantic relationships between different elements in the dashboard. Some implementations perform initial layout parsing. For example, as the user begins constructing the dashboard, the system parses the layout to identify distinct sections, such as individual charts, groups of charts, text elements, and other visual components. Some implementations perform node creation as follows. Each identified section or element is assigned a node in the tree. The nodes represent different components of the dashboard, such as a chart, a title, a label, or a group of related charts. Some implementations determine relationships between nodes as follows. The system analyzes the spatial and semantic relationships between the nodes. For example, if a text element is directly associated with a specific chart (e.g., as a label or annotation), it becomes a child node of that chart's node. Similarly, if multiple charts are grouped together under a common heading or section, they are organized under a parent node representing that section.

Some implementations construct the tree as follows. The system constructs the tree by organizing nodes according to these relationships. The root node typically represents the entire dashboard, with branches representing major sections, and further sub-branches for individual charts and their associated text. Note that the relationship between the visual structure and the semantic structure of text may be specific to a certain genre of data interface. While some implementations are directed to dashboards, and the visual structure is represented by spatial proximity and enclosure of different tiles (or sections), the system could be adapted to generate text for data articles or slide decks by inferring the intended semantic relationships from, for instance, the linear progression of separate slides in a data presentation.

Some implementations perform grid-based parsing. The dashboard layout is first parsed to understand the spatial arrangement of elements. Some implementations analyze the grid structure or layout grid used in the dashboard to determine the relative positions of visual components (charts, text, images).

Some implementations determine proximity and containment as follows. The system identifies which elements are in close proximity or are visually contained within a certain boundary (e.g., a chart and its label). This spatial relationship helps determine parent-child relationships between nodes.

Some implementations perform semantic analysis using content classification: Each element in the dashboard is classified based on its type (e.g., chart, text, annotation) and its role in the dashboard (e.g., title, label, insight).

Some implementations perform role assignment as follows. The system assigns roles to text elements based on their relationship with visual components. For instance, text near a chart may be identified as a label or annotation, while text at the top of a section might be identified as a heading or summary.

Some implementations perform hierarchical dependency modeling as follows. Using the information from spatial and semantic analysis, the system establishes parent-child relationships between nodes. For example, a section heading (text node) becomes the parent node to all charts and related text within that section.

Some implementations perform tree construction as follows. Nodes are organized into a tree structure based on these dependencies. The root node represents the entire dashboard, and branches represent sections, subsections, charts, and associated text elements. The system can use a recursive algorithm to build the tree either top-down or bottom-up.

Some implementations perform dynamic updates and/or adjustments. As users make changes to the dashboard layout, such as moving elements or adding new content, the system dynamically updates the tree structure to reflect these changes.

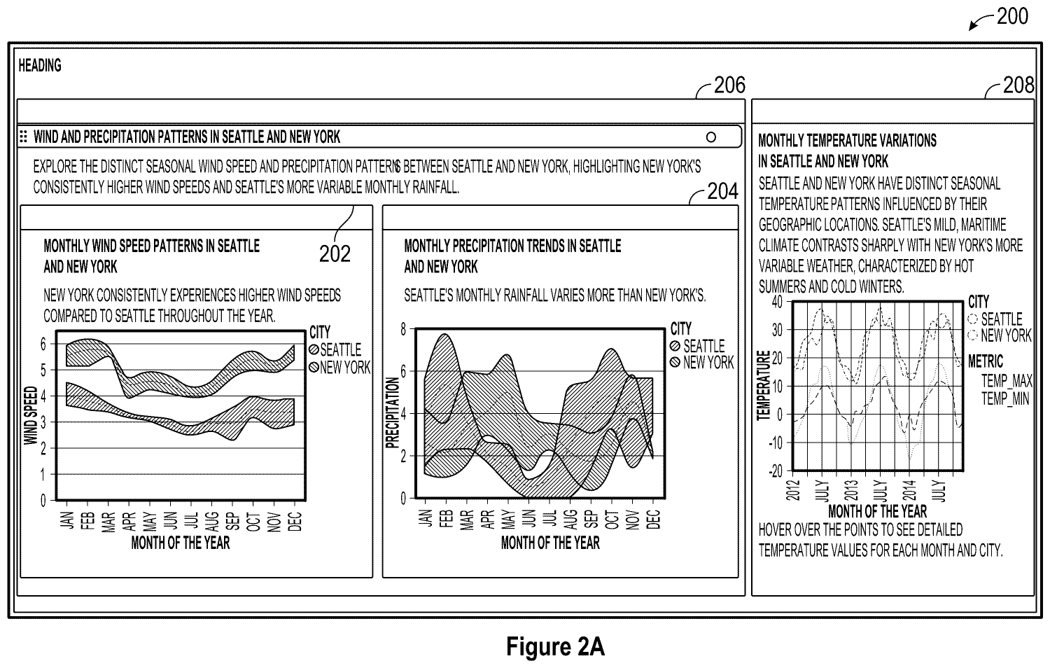

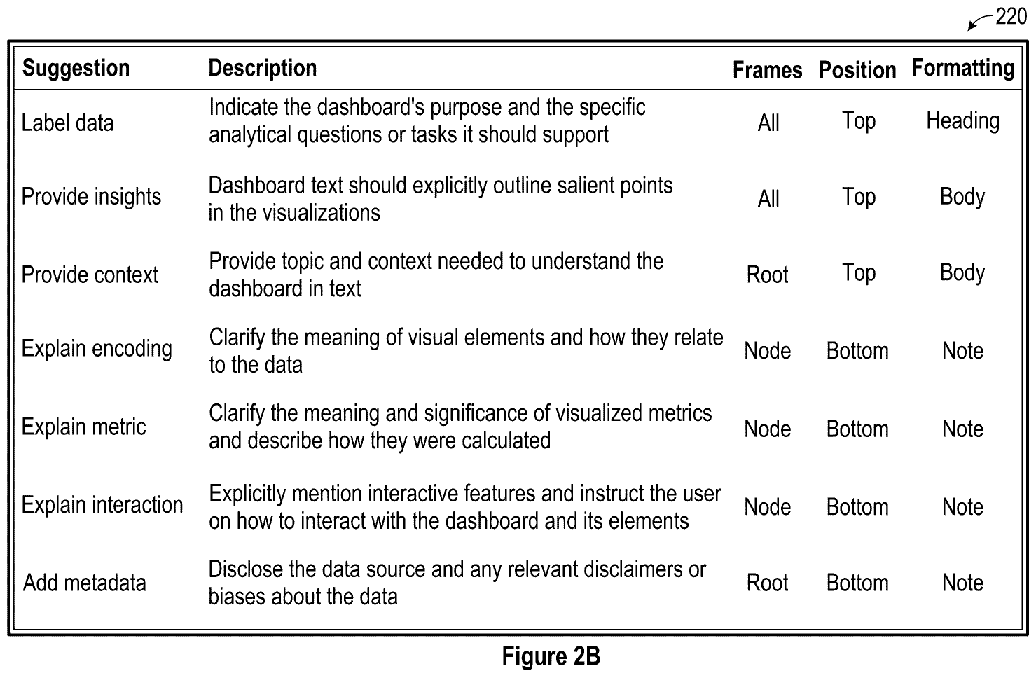

In some implementations, the system surfaces text scope and/or part of the dashboard or the article the text is referring to, by placing text and visualization into a visually salient frame. FIG. 2 is an example view 200 of the graphical user interface 100, according to some implementations. The example shows a scenario with two levels of frames. Inner frames 202 and 204 contain data visualizations and text that refer exclusively to the contents of that frame (wind speed and precipitation, in this example). Meanwhile, the text in the outer frame 206 provides a summary of its children's frames. The text does not depend on the text in its sibling frame to the right. For example, in a dashboard with sections A and B visually fully contained within a larger section C in the layout, the system produces text in section C that summarizes sections A and B.

In some implementations, the system surfaces the relationship between sections of the dashboard by making sure that content, including text or visualization, is enclosed within visible rectangular frames. When a user hovers over a piece of text with a cursor, some implementations additionally highlight direct descendants of that frame, making it particularly noticeable what the text in question is referring to. This highlighting can be seen as the borders for the frames 202 and 204, in FIG. 2. By leveraging the Gestalt principles, in some implementations, the salient enclosures make it easy for a dashboard author, for example, to maintain a semantically meaningful reading order for their text and to verify that information relevant to the visualization is placed near it. Moreover, the layout also allows the author to surface the relative importance of visualizations by adjusting their depth in the dashboard tree. For instance, the author of the dashboard in FIG. 2 can include the frame with the temperature visualization as a sibling frame of the other visualizations. This would, in turn, affect the text contents of their parent frame, which would, in such cases, serve to describe, summarize, and/or contextualize all three views. Besides clarifying text scope for the dashboard authors and viewers, some implementations maintain a dependency tree of dashboard content for placing and generating text.

In some implementations, after an author completes a layout and/or adds visualizations or text/content to relevant frames, the system provides dynamic feedback and/or recommendations for authoring text. Some implementations provide text writing guidance, including global or dashboard-level guidance and/or snippet-level guidance.

Dashboard-level Guidance. In some implementations, the system offers guidance for authors on how to fill out their dashboard. Dashboard-level guidance can include a series of suggestions surfaced in the sidebar that recommend what text may be useful in the dashboard and where it should be placed. The system identifies and offers different types of text, or text roles that typically appear in dashboards. These include, for instance, text that serves to label the data or text that explains how to interact with the dashboard. Each suggestion corresponds to a text role. The system includes, for example, additional reminders to consider readability, reading order, and formatting of the dashboard. The suggestions are intended as flexible rules and may include default values. The suggestions can be dismissed, and text role suggestions can additionally be accepted to generate text or text placeholders for the dashboard. In some implementations, suggestions can also be accepted at once to fill the entire dashboard.

Placeholder text provides users with a template suggestion for what type of text they should add to the dashboard and where it should be placed. Placeholders contain text that explicitly references one of the text types and instructs the user to type it in (e.g., “This would be a good place to label your data”). An example of a placeholder instructing the user to write a context snippet can be seen in the outer frame in FIG. 1. When accepted, placeholders are then put in a relevant position in the frames. Dashboard frames described above are used for placing new text snippets. Firstly, certain text roles may need to appear multiple times throughout the dashboard but differ in their scope. In such cases, placing text on different frame levels helps the system distinguish between a suggestion to describe an insight about an individual chart versus providing a takeaway insight for the whole dashboard. Secondly, certain types of text are only relevant for frames on one specific level of the dashboard frame tree. For instance, authorship credits typically appear only once in the outermost or root frame. Meanwhile, text explaining how to interact with a given chart is typically found immediately adjacent to the relevant chart or a leaf frame. In either case, maintaining a clear relationship between the frames allows the system to place the suggestion in the most appropriate position. FIG. 2B is a table 220 that shows example global guidance suggestions and their corresponding addition of text to dashboard upon acceptance, according to some implementations. In some implementations, the suggestions are based on snippet text roles. Example description, frames, position and formatting for each suggestion, are shown. The example shows text role-based suggestions and their corresponding placeholder placements upon acceptance, according to some implementations.

Snippet-level Guidance. After text snippets are placed in the dashboard, some implementations provide more granular guidance on how to write meaningful and/or easy-to-read text. For example, the system provides recommendations for writing text specific to each of the text roles based on text readability and/or writing guidance. In some implementations, each recommendation consists of a short overview description followed by concrete guidelines in terms of word count, word variety, and readability. The recommendation is accompanied by a visualization of how the metric guidelines apply to the text snippet.

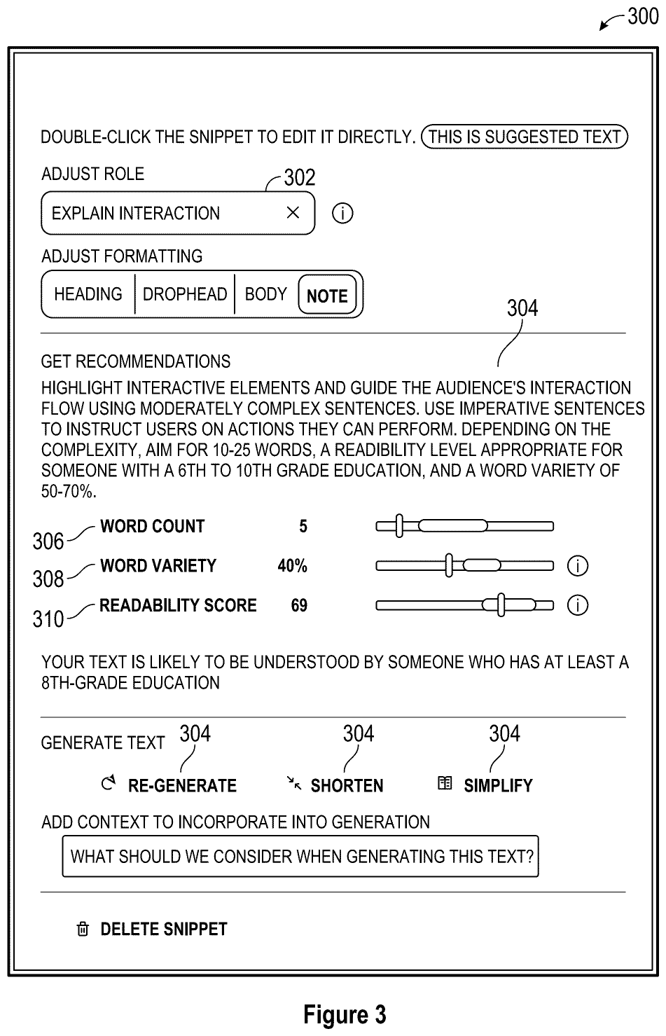

FIG. 3 shows an example graphical user interface 300, according to some implementations. Some implementations provide a dropdown menu 302 when a text snippet is clicked on. Based on a selected text role, some implementations provide recommendations 304 on writing such text and/or surface text metrics. The user may then either manually rewrite the text or use the system to re-generate, shorten, or simplify their text, for example by selecting one of the affordances 304, to ensure that the text is readable at an appropriate level. Some implementations show a word count 306 to indicate an appropriate word count level for a text (e.g., based on its role). To measure word variety 308, some implementations calculate the snippet's lexical density measured as percentage of content words among all words in the snippet. In some implementations, the system defines content words as those outside of NLTK's list of English stopwords and/or calculates readability score 310, for example using Flesch-Kincaid readability tests formula.

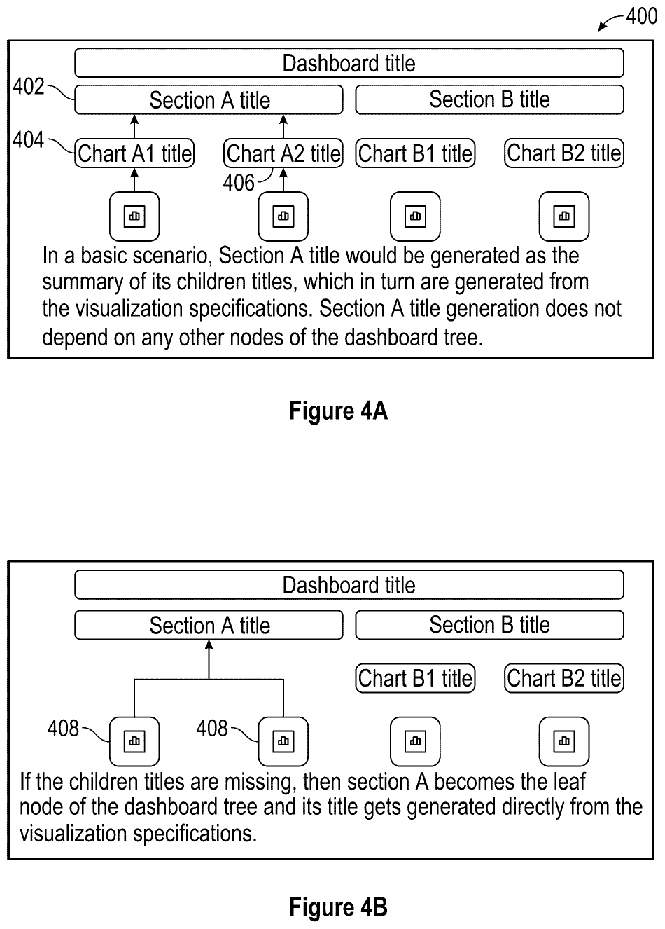

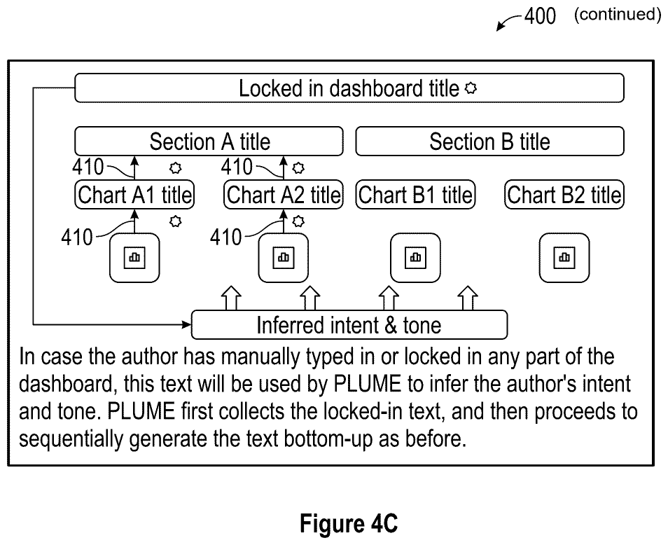

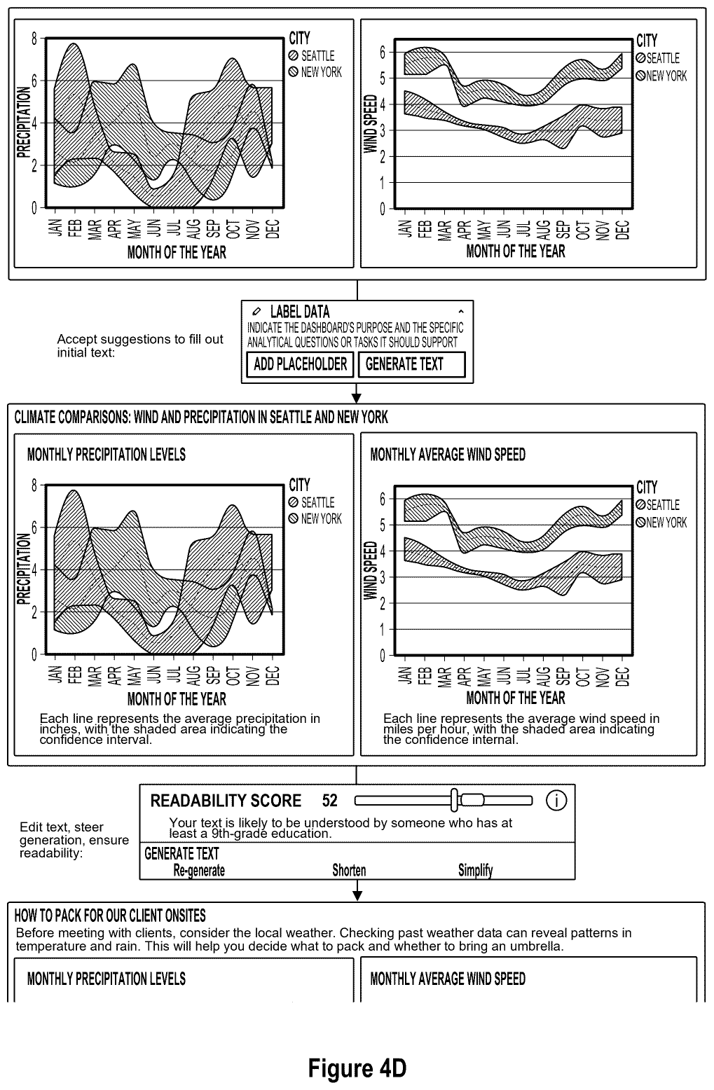

Text Generation. Some implementations provide an option for a user to select an affordance (e.g., press a text generation button). In response to the selection, the system generates text instead of the user writing their own text based on snippet-level suggestions. The system generates text by sending a prompt to a large language model (LLM), according to some implementations. The prompt includes, for example, (i) an instruction that is specific to each text type, (ii) examples of the text type extracted from exemplary dashboards, and/or (iii) the relevant context from the dashboard. The context can depend on the text type and the position of the text in the dashboard frames or sections of an article. Some implementations use different types of relevant context for the prompt, examples of which follow:
Chart specification, which is the code that is used to specify the chart explicitly or implicitly, contains data semantics, data types, transformations, encodings, and interaction specifications. This information is important, for instance, when generating a prompt for text explaining how to interact with a chart.
Chart visuals, or Scalable Vector Graphics (SVG) code of the resulting visualization, which allows the LLM to infer what patterns or trends the chart is showing. This information is included in prompts that generate insights or takeaways from the chart.
Downstream text, or the text previously written or generated in the children frames, or frames downstream of the current frame. If, for a given text role, there exists downstream text then the prompt can request a summary or comparison of that text rather than generating new text from the charts. This helps ensure that the generated text (e.g., dashboard takeaway) is consistent with and logically follows the text that comes later in the dashboard (e.g., individual chart insights), avoiding contradictions or non-sequiturs.
Locked in text, which is any text across the dashboard that has been manually entered or marked locked in by the user, can be used in the prompts. Such text serves as an indicator of the intent of the dashboard, any external context not otherwise inferred from the data that the author would like to add, as well as tone and phrasing. As a result, users can steer the text generation by the system by seeding the dashboard by filling out part of the text and generating the rest. An example is illustrated in FIG. 4C.

Exemplary dashboards are curated examples of high-quality dashboards that exemplify best practices in dashboard design, text composition, and data visualization. These dashboards are typically created by experts or derived from widely recognized templates in the industry. They are designed to cover a range of scenarios, such as financial reports, sales dashboards, operational dashboards, and more. The system determines the relevance of text examples through a comprehensive process that begins with a detailed contextual analysis of the current dashboard. It first identifies the role of the text that needs to be generated, such as a title, label, or insight, and then analyzes the type of visualization and data context, including the specific attributes of the data and its visual representation.

In some implementations, the system also considers the position of the text within the dashboard's hierarchical structure, using the dashboard frame tree to understand relationships between different sections and elements. User preferences. The specific order of generating inner text (dependent on charts) before outer text (dependent on the inner text) is useful for ensuring contextual accuracy and maintaining hierarchical consistency in the dashboard's narrative. Inner text provides the details directly tied to visualizations, such as labels and insights, which are essential for accurately capturing data-specific information. Generating this text first allows the outer text, which often summarizes or contextualizes the data, resulting in a coherent and logically structured narrative. These mechanisms allow the system to revise outer text in real-time, ensuring consistency across the dashboard. Additionally, users have the ability to manually adjust text and lock snippets to prevent unwanted changes, giving them control over the narrative and helping to maintain alignment with the visualized data.

In some implementations, the system handles potential conflicts or inconsistencies that might arise from the generation order by employing dynamic updates, contextual checks, and conflict resolution rules. As inner text is generated first, the system continuously monitors for any discrepancies between the inner and outer text. If a conflict is detected, such as a mismatch in data interpretation, the system can automatically update the outer text to ensure consistency or offer options to regenerate it based on the latest inner text.

In some implementations, the system defines and measures semantic coherence in the context of a dashboard by ensuring that all text elements consistently align with the visual content, data context, and overall narrative flow. Semantic coherence is achieved through contextual alignment, where each text element accurately reflects the data it describes and is relevant to the specific visualization it accompanies. The system also ensures consistency across related text elements, avoiding contradictions or varying interpretations of the same data. Additionally, it maintains a logical flow and hierarchy, with detailed text building up to broader summaries, ensuring a coherent progression of information. As the user refines the dashboard and adjusts the language, the system tracks these changes to maintain semantic consistency with the existing content. This approach ensures that the dashboard's text forms a unified and meaningful narrative that accurately represents the data and supports the user's intent.

In some implementations, the system identifies and represents visual containment relationships by analyzing the spatial arrangement and hierarchical structure of the dashboard elements, ensuring that each piece of text and each visualization is placed within a visually salient frame that clearly defines its scope. This process begins by examining the layout of the dashboard, where the system looks for visual or structural cues such as proximity, alignment, and grouping of elements. These cues help the system determine which text is associated with which visualizations, enabling it to create frames that visually enclose related content. For example, if a chart and its descriptive text are positioned close together, the system will group them within the same frame to indicate their relationship.

In some implementations, the system analyzes locked-in text to infer the author's intent and tone by examining the language, style, and content of the text that has been manually entered or locked by the user. It begins by identifying key linguistic features such as word choice, sentence structure, and punctuation, which help determine the overall tone—whether it is formal, casual, persuasive, or descriptive. The system also considers the context in which the locked-in text appears, including the data it references and its relationship to surrounding text and visual elements.

In some implementations, the system combines factors such as text role, word count, word variety, and readability to generate recommendations by using a weighted algorithm that takes into account the specific needs of each text element within the dashboard's hierarchical structure. The algorithm first identifies the appropriate text role (e.g., title, context, insight) based on the position of a given frame within the dashboard frame tree and the contents it encloses. For instance, a frame at the top of a section with a broad overview might be assigned a title or summary role, while a frame directly associated with a specific chart may be assigned an insight or annotation role. Once the text role is determined, the system applies concrete guidelines for word count, word variety, and readability. Titles might have stricter limits on word count and require higher readability, ensuring they are concise and easy to understand. In contrast, context or insight text may allow for more word variety and slightly longer word count to convey detailed information effectively.

In some implementations, readability metrics are adjusted based on the role, with more accessible language used for broader audiences (e.g., in summaries) and more specialized language in detailed insights.

### Example Metrics or Methods Used to Assess Readability and Coherence in Real-Time

Some implementations use metrics, such as the Flesch-Kincaid readability score, which evaluates the complexity of the text based on sentence length and word syllable count, ensuring that the content is accessible to the intended audience. Additionally, some implementations monitor word variety to avoid redundancy and maintain engagement, and it checks for appropriate word count relative to the text's role (e.g., titles being concise, insights being more detailed). To assess coherence, some implementations analyze the logical flow between text elements, ensuring that each piece of text aligns with the overall narrative structure and accurately reflects the data or visualizations it accompanies. Some implementations also consider the hierarchical relationships within the dashboard, ensuring that the text maintains a consistent tone and intent across different sections.

### Example Determination of Important Missing Elements and Prioritization of Suggestions

Some implementations determine important missing elements within the dashboard and/or prioritize suggestions for adding these elements. For this, the system analyzes the dashboard's structure, content, and the relationships between visualizations and text. The system identifies gaps where essential text or visual elements might be missing, such as a lack of context for a particular chart, missing titles or labels, or insufficient explanations of key data points. Once these gaps are identified, the system prioritizes suggestions based on the importance of the missing element to the overall narrative and user comprehension. For instance, missing titles or labels that are crucial for understanding the data are prioritized higher than additional contextual information. The system also considers the user's intent and the dashboard's purpose, offering suggestions that align with the intended message and enhance the clarity and effectiveness of the dashboard.

Examples of Alerts Generated when Automatic Updates Affect the Overall Narrative

Some implementations generate alerts when automatic updates affect the overall narrative of the dashboard, ensuring that users are aware of changes that could impact the coherence or accuracy of the content. For example, if new data is added that significantly alters a trend previously described in the text, the system might alert the user that the existing narrative no longer accurately reflects the updated data. Similarly, if an automatic update leads to changes in visualizations that disconnect them from their associated text (e.g., a chart is modified but the text still references old data points), the system can generate an alert advising the user to review and possibly revise the text.

Example Criteria or Thresholds Used to Determine when a Change in the Underlying Data is Significant Enough to Trigger an Update

Some implementations use specific criteria and thresholds to determine when a change in the underlying data is significant enough to trigger an update in the dashboard's content. These criteria include changes in key metrics or data points that exceed predefined thresholds, such as percentage increases or decreases in values that are critical to the narrative, like sales figures, performance indicators, or trends. For instance, if a sales metric changes by more than 10%, the system might consider this significant enough to warrant a text update. Additionally, in some implementations, the system monitors for shifts in data patterns, such as a trend reversal or the emergence of a new trend that contradicts previously described insights. The system also considers the role and prominence of the affected data within the dashboard; changes in data that are central to the dashboard's main message are more likely to trigger an

### Examples of Tracking and Analyzing User Interactions to Identify Areas of Interest or Confusion

In some implementations, the system tracks and/or analyzes user interactions by monitoring how users engage with different elements of the dashboard, such as clicks, hovers, and time spent on specific visualizations or text sections. For example, if a user frequently hovers over a particular chart or repeatedly clicks on a specific data point, the system recognizes these behaviors as indicators of interest. Similarly, if users spend more time reading certain text sections or revisiting them multiple times, the system flags these areas as potentially confusing or particularly important.

In some implementations, the system also tracks user edits, such as changes to automatically generated text or adjustments to visualizations, to understand which aspects of the content may need further clarification or refinement. By analyzing these interactions, the system could suggest improvements, such as adding more detailed explanations, clarifying ambiguous text, or providing additional data insights,

### Example Text Generation Process

FIGS. 4A-4C show an example text generation process 400 for different scenarios, according to some implementations. Some implementations use a dashboard dependency tree for identifying relevant context for text generation. In the example scenario shown in FIG. 4A, the system uses downstream text for context. The system enforces an asynchronous order of text generation. For example, if many snippets across the dashboard are to be generated, the text in the leaf frames is generated first and then passed upwards to its parent frames, with the root frame being generated last. In the example scenario in FIG. 4A, Section A title 402 can be generated as a summary of its children titles (chart A1 title 404 and chart A2 title 406), which in turn can be generated from the visual specifications of the respective charts. Section A title generation does not depend on any other nodes of the dashboard tree. FIG. 4B shows another scenario whereby, for example, if the children titles are missing, then Section A becomes the leaf node of the dashboard tree and its title gets generated directly from the visualization specifications (e.g., visualization specifications for the charts 408).

To produce meaningful text, some implementations maintain information about the content within the text's scope and/or use an order of generation. For example, inner text (e.g., text dependent on charts) is generated before outer text (e.g., text dependent on the inner text). To ensure consistency throughout the entire dashboard or article, upstream or sibling text that has been manually entered or locked can be used to infer the author's intent. For example, if a dashboard title highlights a specific insight, the generated text should also support that insight. FIG. 4C shows yet an example scenario, where an author (e.g., an author of a dashboard or an article) has manually typed in or locked in any part of a dashboard or an article (e.g., 410), the corresponding text can be used by the system to infer the author's intent and/or tone. In some implementations, the system collects the locked-in text and then sequentially generates the text bottom-up as before.

In some implementations, the techniques described herein are implemented as a web-based browser application. Some implementations use Python and Flask for the back end and React, HTML/CSS, and TypeScript for the front end. In some implementations, OpenAI's ChatGPT 40 LLM is used to generate text. In some implementations, visualizations in the system are specified using Vega-Lite.

### Example Usage Scenario

FIG. 4D shows an illustration of an example usage scenario, according to some implementations. The example corresponds to a scenario during the creation of a visualization dashboard to compare weather patterns in Seattle and New York. The process begins, for example, when a user configures a dashboard layout using the system. This can include, for example, defining various frames that will each contain specific visualizations or nested subsections. With the layout established, the system proceeds to a text authoring phase. In some implementations, the system provides a panel with text recommendations with best practices for effective dashboard text composition. The user can review each suggestion sequentially. The initial recommendation can advise adding labels to the sections of the dashboard.

By clicking a generate text button, for example, the user causes the system to automatically generate and/or place text based on the visualizations on the canvas. This can include, for example, positioning the text at the top of each section and formatting it in large, bold letters. The subsequent suggestion can provide instruction to the user to incorporate insights into the dashboard. Suppose the user chooses to bypass this suggestion to opt for a more exploratory approach. Further suppose that the user accepts another recommendation from the system to clarify the visual elements of the visualizations. Upon acceptance, the system inserts explanatory notes under each visualization, detailing how to interpret the charts. This is useful for a line chart featuring shaded areas—for instance, created by another team member—where the current user was unsure of the calculations. In some implementations, the system deduces from the visualization specifications, for example, that these shaded areas represent 95% confidence intervals and includes this explanation in the text.

In some implementations, subsequently, the system provides suggestions to add metadata to the dashboard. Instead of generating text automatically, for example, the system prompts the user to specify the author, data source, and any disclaimers or caveats. The user notes that the 2024 data is incomplete and partially imputed, which can be crucial information for viewers. Suppose the user enters this detail into a text box. The system incorporates the metadata into an English sentence at the bottom of the dashboard.

Upon reviewing the dashboard, the user can decide to refine the message. Instead of merely exploring weather patterns, the user aims to create a dashboard that informs viewers about packing for client visits. The user can, for example, rename the dashboard to How to Pack for Our Client Onsite by double-clicking the generated title and making the change. By clicking the checkmark, the user can lock in the updated title. The user can then accept a suggestion to provide context in the sidebar, which can generate a paragraph under the dashboard title. This paragraph reflects the new title and infers the dashboard's intent, advising viewers to prepare for trips by, for example, packing an umbrella for Seattle's rainy season.

In some implementations, a subsequent sidebar suggestion prompts the user to evaluate the readability of the text. The user can access each snippet's dropdown menu to adjust its role, formatting, and prominence. Using the system's readability metrics, the user notices that the context paragraph has a low readability score, indicating it may be too complex for some readers. The user can click a simplify button, for example, prompting the system to rewrite the text to improve clarity. The revised text is now more accessible.

As illustrated by the example described above, with a few clicks (e.g., 5-6 clicks) and writing a few phrases (e.g., 3 phrases), the dashboard provides text guiding its audience in how to use it, including a data caveat and encoding clarification that the user would have otherwise forgotten to include. The user continues to refine the dashboard, manually adjusting the language and accepting a suggestion to describe interactions with the charts. Subsequently, the system provides a print preview mode to review the dashboard without system controls, and then shares the dashboard, according to some implementations.

### Formative Survey of Dashboards

Some implementations are directed to formative survey(s) to inform designs (e.g., text formatting, text styling, etc.) of dashboards displayed by the system.

In some implementations, a formative qualitative analysis of exemplar uses of text in dashboards is conducted to inform the design of the system. Results of the formative qualitative analysis are used to derive themes and considerations. In some implementations, a fine-grained survey of text in a set of exemplar dashboards is conducted to inform a tool design and identify a set of dashboard text characteristics necessary for generation. In some implementations, a corpus of dashboards are constructed. To arrive at a set of exemplary instances of text in dashboards rather than simply a representative sample, a set of 40 dashboards are chosen and identified as examples of “Strong Application” of their proposed heuristics for the use of text. The sample covers a variety of dashboard genres (e.g., 13 analytic, 20 infographic, 7 other) and sources (e.g., 30 Tableau Public, 8 Power BI, 2 other web visualization tools). The corpus of dashboards is processed by extracting all textual elements using OCR and further separating the text into the smallest possible fragments of text prose, e.g., phrases, sentences, or short paragraphs, that described the same idea or action and had the same formatting. These text fragments snippets are termed, which form the basic unit of the analysis. The corpus results in 672 snippets, e.g., just under 17 snippets per dashboard, on average.

In some implementations, a thematic analysis of the resulting 672 snippets is conducted using a template analysis approach. Template analysis is particularly well-suited for several reasons. First, it focuses on creating a hierarchical codebook of codes called the template. Since a goal is to identify key parameters and dimensions of dashboard text, e.g., both to suggest these parameters to users and to design descriptive prompts for future LLM generation, a meaningful codebook can be constructed and validated. Second, unlike grounded theory approaches, template analysis does not claim to report a ground truth set of codes that exist outside the context of our study. Instead, codes are inductively hypothesized that guide the analysis toward aspects of dashboard text relevant to tool design. In some implementations, a complete coding of the data set is performed. For example, following the template analysis protocol, a respective author of a group of authors creates an initial coding template based on the research goals, a review of relevant literature, and an examination of 6 of the 40 dashboards used in the analysis. The group of authors determine whether the codebook captured dimensions relevant to tool design and whether the codes are understandable. The respective author of the group of authors proceeds to code 30 dashboards, iteratively updating and refining the template. Subsequently, a respective senior author of the group of authors conducts a quality check by independently coding the remaining ten dashboards, confirming that the codebook is straightforward to apply and captured all relevant dimensions. Throughout this process, the group of authors meets daily to discuss changes. By the end, the final codebook is completed, and the respective author of the group of authors reviews the entire sample of snippets to ensure it was coded according to the latest version of the codebook.

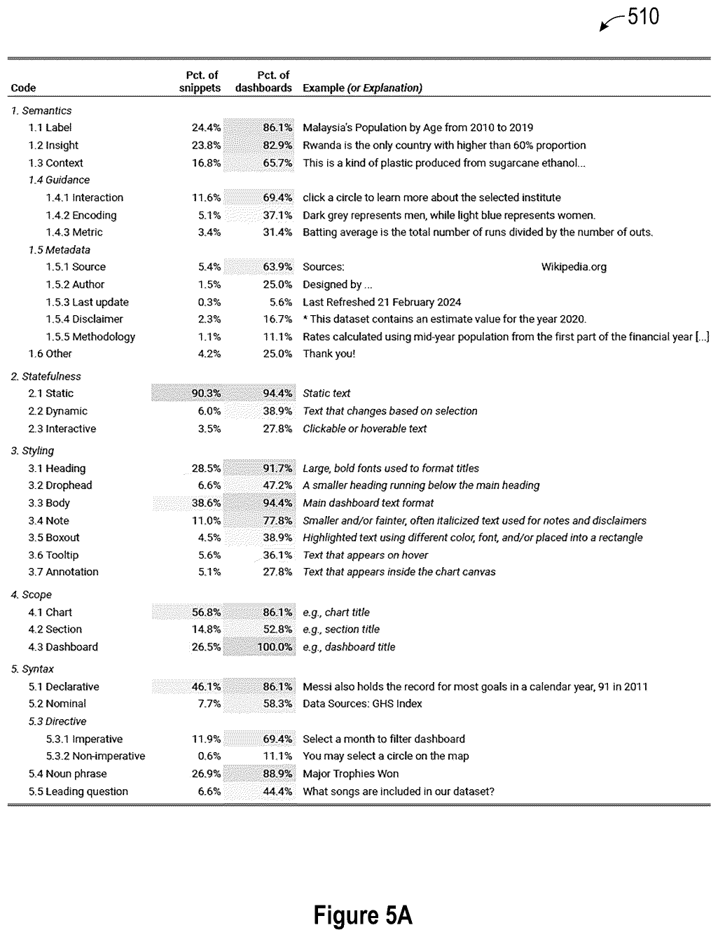

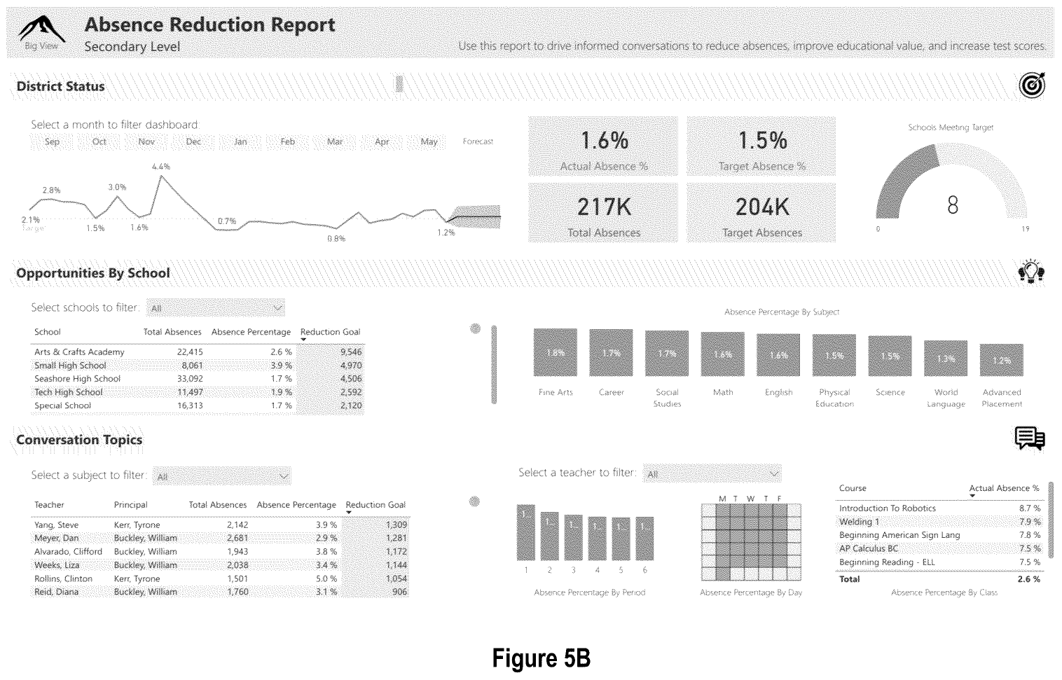

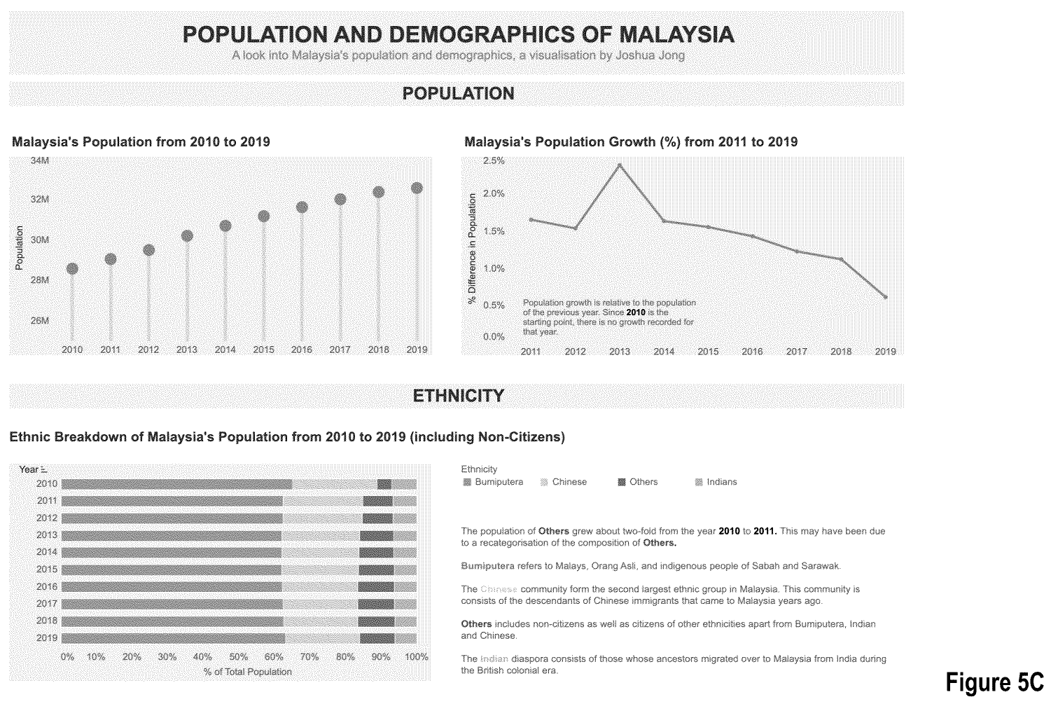

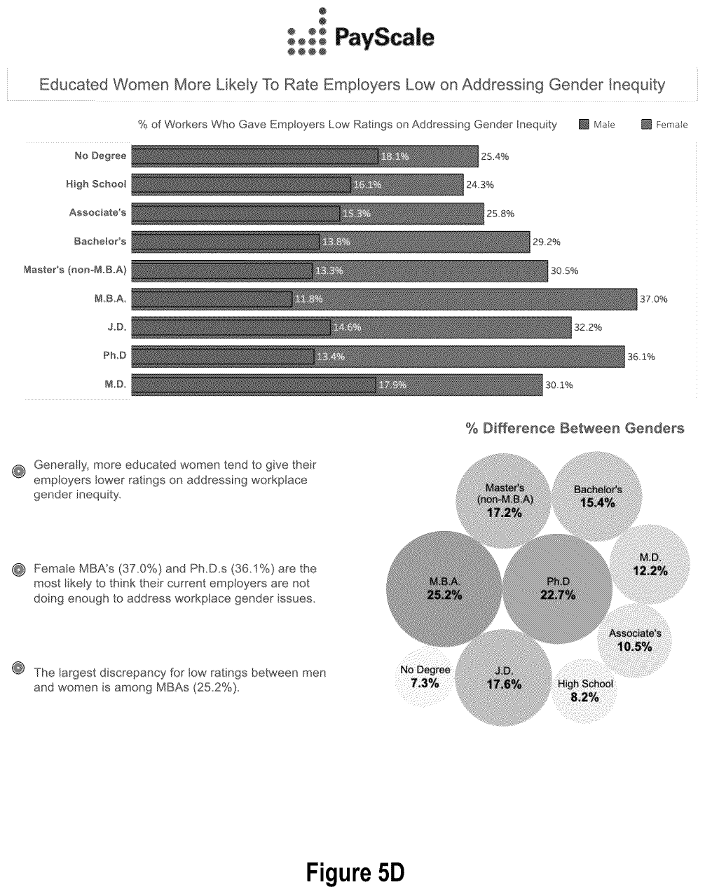

FIG. 5A illustrates a codebook 510 that is used to code all text snippets, according to some implementations. In particular, the codebook 510 in FIG. 5A comes along with the prevalence of each code across all snippets and dashboards. In some implementations, the codebook 510 is presented as a set of themes, and each theme reflects an observation about a group of codes or a contrast between sets of codes. These themes highlight opportunities to provide dashboard authors (e.g., users) with scaffolding that supports and simplifies common text practices. Additionally, each theme also reflects a tension between being too prescriptive and allowing authors (e.g., users) complete freedom to modify their dashboard text.

In some implementations, 96% of all text snippets in the formative survey align with one of the identified semantic goals represented by codes 1.1-1.6 in FIG. 5A, such as labeling data, explaining visuals, or surfacing disclaimers. The vast majority of dashboard text serves one of these common roles. In some implementations, a quarter of the dashboards include at least one snippet that does not fit these roles, e.g., code 1.6 in FIG. 5A. Such text includes messages from the author (e.g., “Thank you!”), serves as a creative outlet, or includes song lyrics and poems relevant to the data theme. In some implementations, the system surfaces common semantic goals as options or suggestions, provides easy ways to place, generates each of them, and offers guidance on how to author them when the user prefers to do so manually. In some implementations, the system allows the user to input any other text that may not directly fit these common goals.

FIGS. 5B-5D illustrate example dashboards, according to some implementations. In particular, FIG. 5B illustrates a dashboard tracking absences in school, FIG. 5C illustrates a dashboard visualizing demographics of a country, and FIG. 5D illustrates a dashboard analyzing the gender pay gap. In some implementations, the dashboards in the formative study display varying levels of coordination between the visual layout of text and its semantic scope. In some implementations, the Gestalt principle of proximity helps trace which part of the dashboard each text describes, though with differing clarity. For example, the dashboard in FIG. 5B uses a rigid grid, with each text placed directly above the relevant chart, section, or entire dashboard. In another example, the dashboard in FIG. 5C employs a grid but in some situations it places text to the side of the chart or as an annotation on top of it while maintaining clear associations. In yet another example, the dashboard in FIG. 5D places most text in its own section equidistant from two views, making it harder to visually infer the corresponding view.

The formative survey indicated strong correlations between the semantic goal of text (codes), its scope (codes), and its positioning and formatting (codes). For example, as shown in dashboards in FIGS. 5B-5D, data labels are formatted as headings and placed at the top of charts, sections, or the entire dashboard. Similarly, metadata is formatted in a smaller, fainter font and placed at the bottom or in the corners of the dashboard. While such formatting and placement choices are common across text modalities, they are also influenced by an author's stylistic preferences, intended reading order, or desire to draw attention to specific text or sections of the dashboard. In some implementations, the system selects appropriate formatting and placement for text depending on its semantic goal by default. In some circumstances, since text formatting also reflects stylistic and design choices by the author, the system allows users the flexibility to modify the placement and formatting of text.

In some implementations, while all semantic goals of text coexist within the dashboard and contribute to the audience's understanding, an author (e.g., a user) draws on different information sources to craft them. For example, when writing a data label, the author understands the semantics of the data. When offering context, the author also incorporates world knowledge and consider the audience's perspective. Consequently, the system that offers text generation would similarly need to draw on different sources of information, such as the raw data or the visualization specification, to effectively support the author. In some implementations, three categories of text semantic goals are identified in terms of generation potential and expected accuracy: text that can be accurately generated based on information readily available to the system (e.g., labels and guidance text), text that can be generated but requires approval or direction from the author (e.g., insights and context), and text that necessitates user input (e.g., disclaimers and methodology). While L1 and L2 semantic levels may be straightforward to generate, current technology often struggles with producing accurate and relevant higher-level L3 and L4 descriptions of the visualization. In some implementations, LLM prompts for different semantic goals of text would need to include various types of relevant information, such as the raw data or the visualization specification. The system avoids guessing or generating content without the necessary information and instead prompt the user to specify missing details. Additionally, the system does not always assume that LLM-generated text reflects the user's intentions and offers ways for users to steer the generation by editing, augmenting prompts, and marking certain text as generated as intended.

In some implementations, codes in the codebook (e.g., in reference to FIG. 5A) indicate that each text fragment refers to either a single chart, a group of charts, or the entire dashboard. For example, an encoding text snippet offers guidance on how to read a particular chart or set of charts, while a label can refer to a specific chart or the whole dashboard. Text scope is primarily a semantic property, but it is closely tied to its visual appearance. In some implementations, text that refers to a specific chart or dashboard section is visually connected to it through Gestalt principles, such as proximity or enclosure. In some implementations, relevant text appears adjacent to the chart it describes and reside within the same enclosed region. Such relationship is often nested, as shown in FIGS. 5B and 5C, where the semantic scope of the text aligns clearly with the visual scope. In some implementations, the dashboard in FIG. 5D diverges from the pattern discussed above. Insights are presented as bullet points equidistant from two views, without a clear visual cue to indicate which view the text refers to. In some circumstances, a viewer may carefully read the text and examine both charts, making it more difficult to quickly grasp the relationship between the text and the visual data, reducing overall clarity. In some implementations, for readability and quicker comprehension, it is important that text is clearly visually related to the chart or dashboard section it describes. The system ensures that text scope is reflected visually to aid in the quick understanding of references. Additionally, the scope of text is surfaced to the LLM generation to ensure a sensible reading order in the generated text.

### Exemplary Dashboard Text Generation

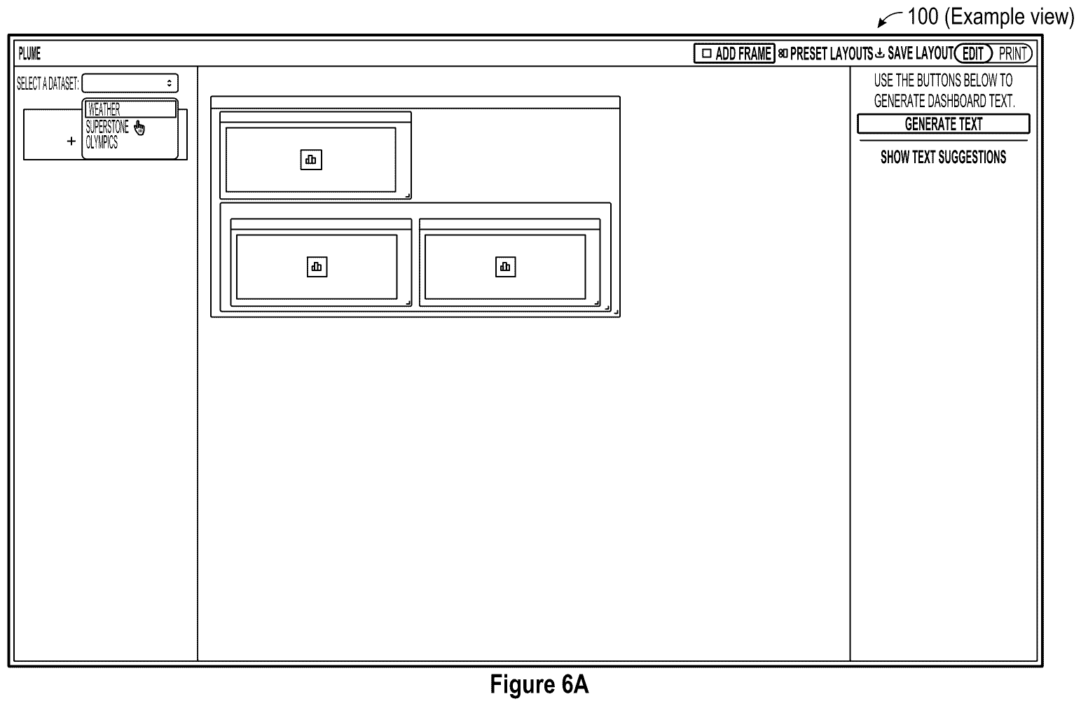

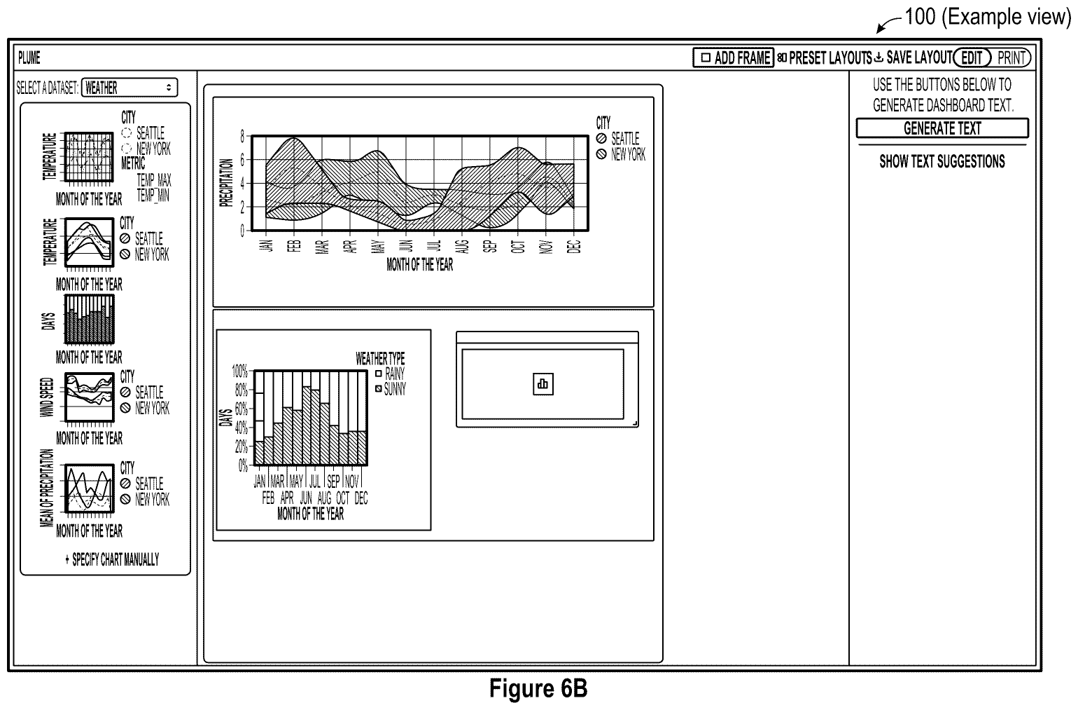

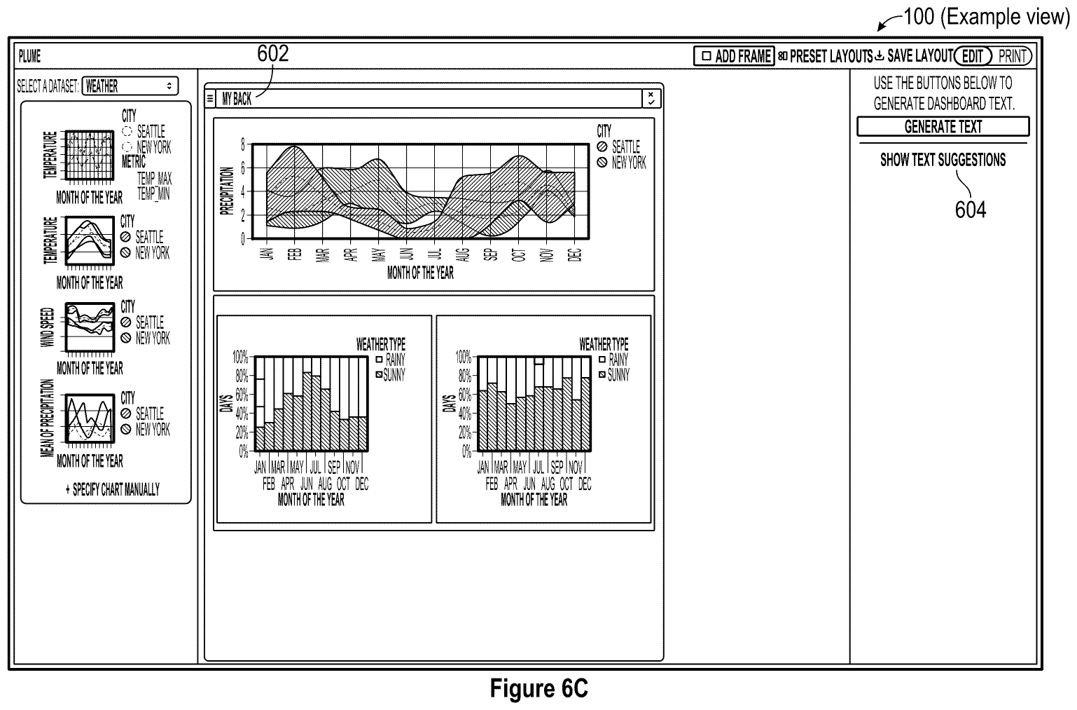

FIGS. 6A-16 illustrate an example process for generating dashboard text, according to some implementations. Suppose a user starts by adding frames to a canvas, an example view of which is shown in FIG. 6A. A frame may include another frame or previously made visualizations that the user adds as shown in FIG. 6B. Some implementations allow a user to add text to a frame by employing a text box 602 within the frame as shown in FIG. 6C. However, manual text creation leads to work duplication, for instance when a visualization changes. Some implementations recommend text for the dashboard based on what they know about the dashboard—the data, visualizations, and the layout as well as best practices for composing effective texts for visualization dashboards. The user clicks on affordance 604 to show text suggestions.

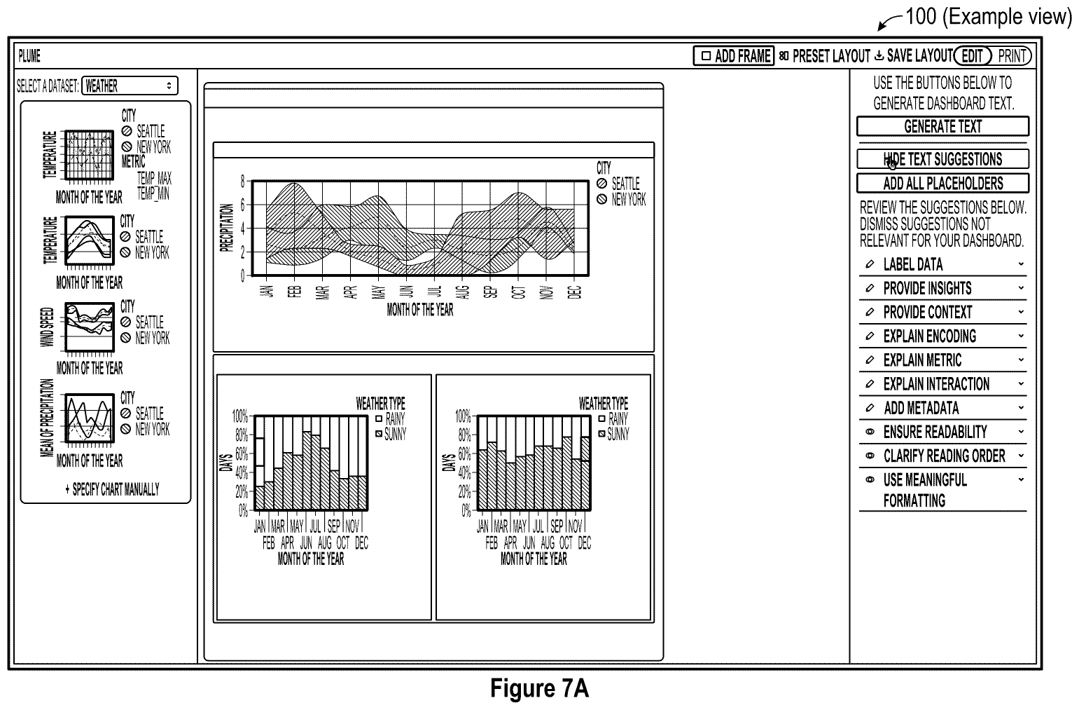

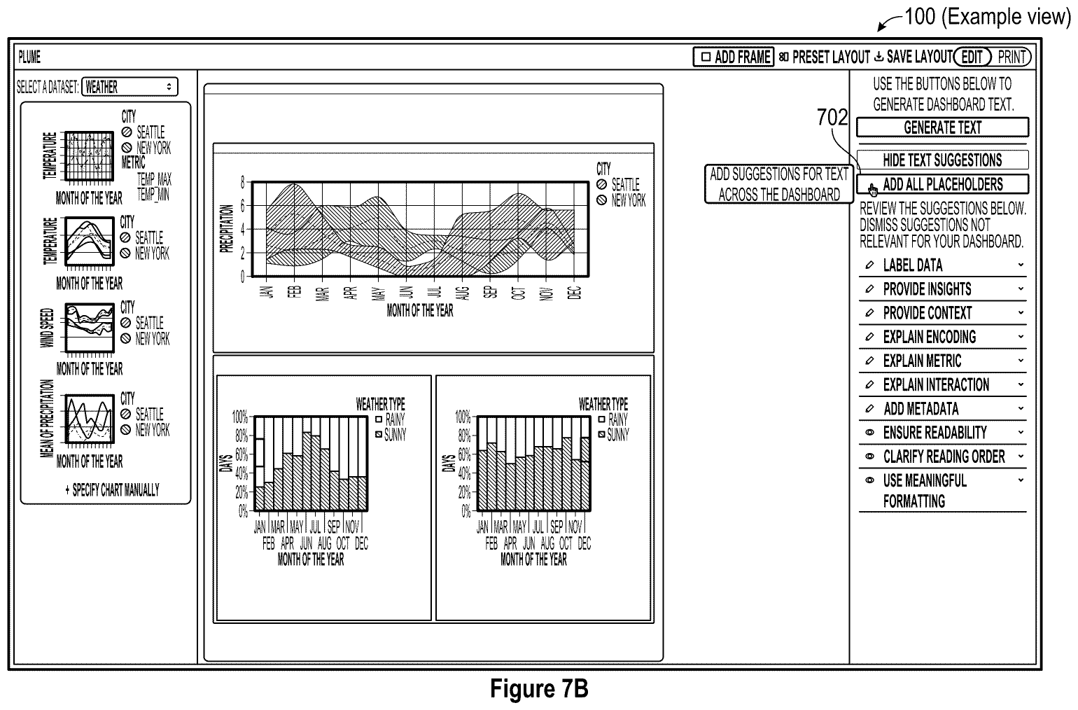

FIG. 7A shows a panel of suggestions revealed as a result. FIG. 7B shows the affordance 702 in this panel that allows the user to add all text suggestions to the dashboard. The user may ignore this option and instead go through each of the other listed selections individually. These include Label data, Provide insights, Provide context, etc.

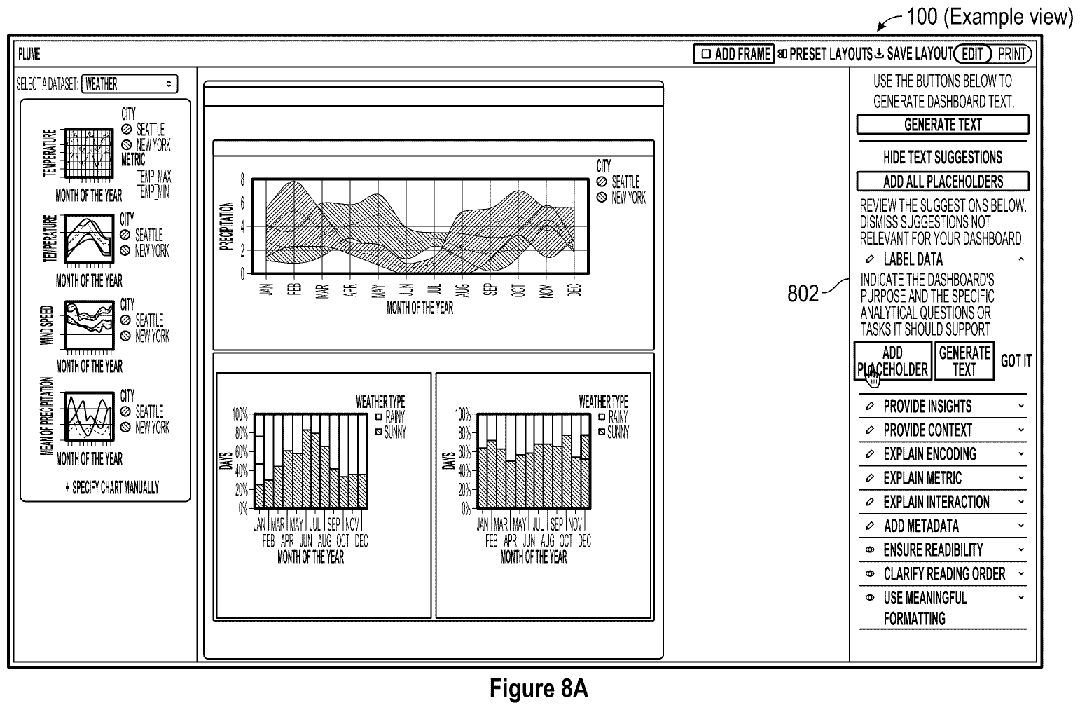

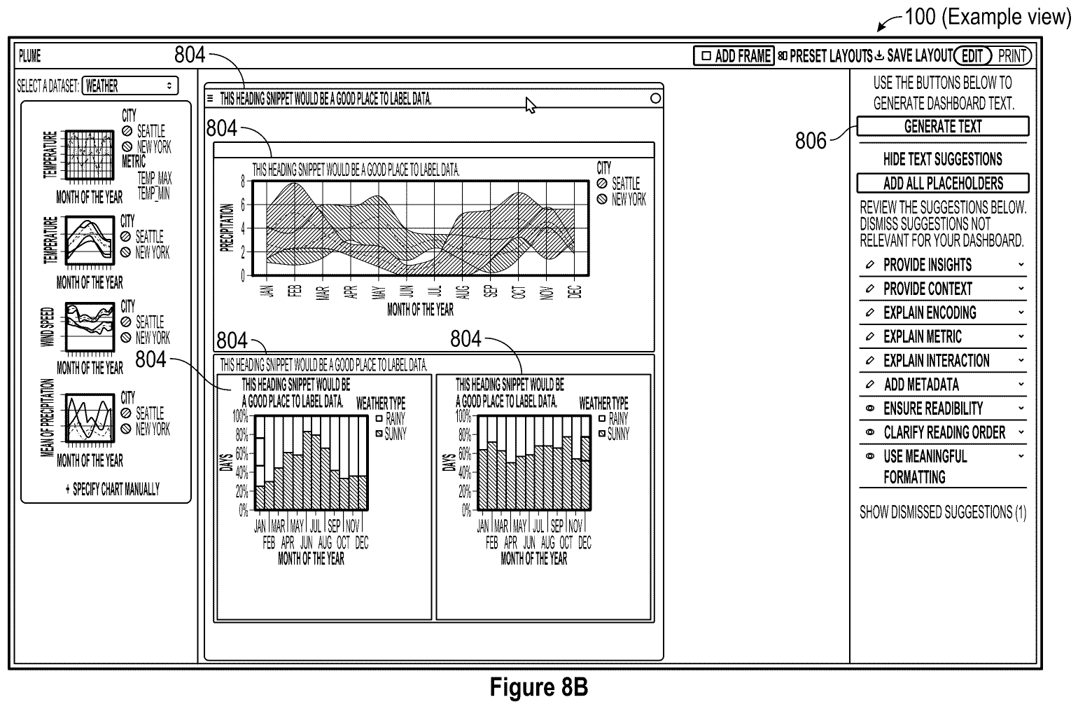

FIG. 8A shows the user selecting an option, 802, according to some implementations, to generate data label placeholders for the user to write the text. The user may choose for the text to be generated automatically or may choose to dismiss the suggestion.

FIG. 8B shows placeholders 804 placed at appropriate positions and with appropriate formatting with reminders for the user to write the data labels. FIG. 8B also shows button 806 that the user can click to generate text automatically.

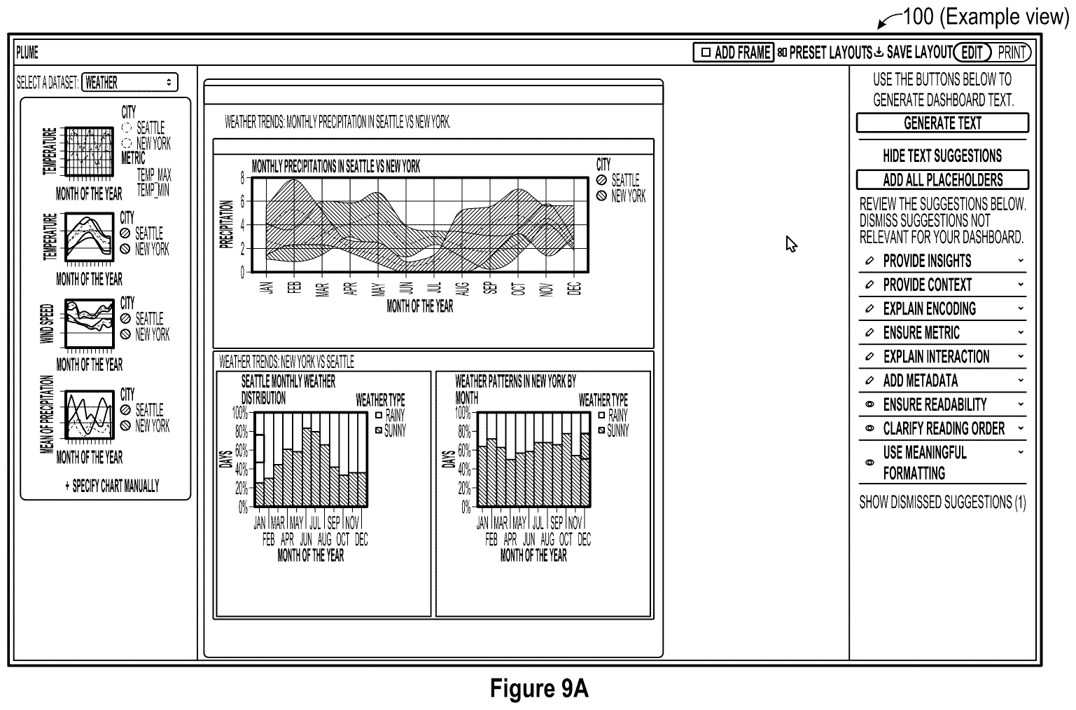

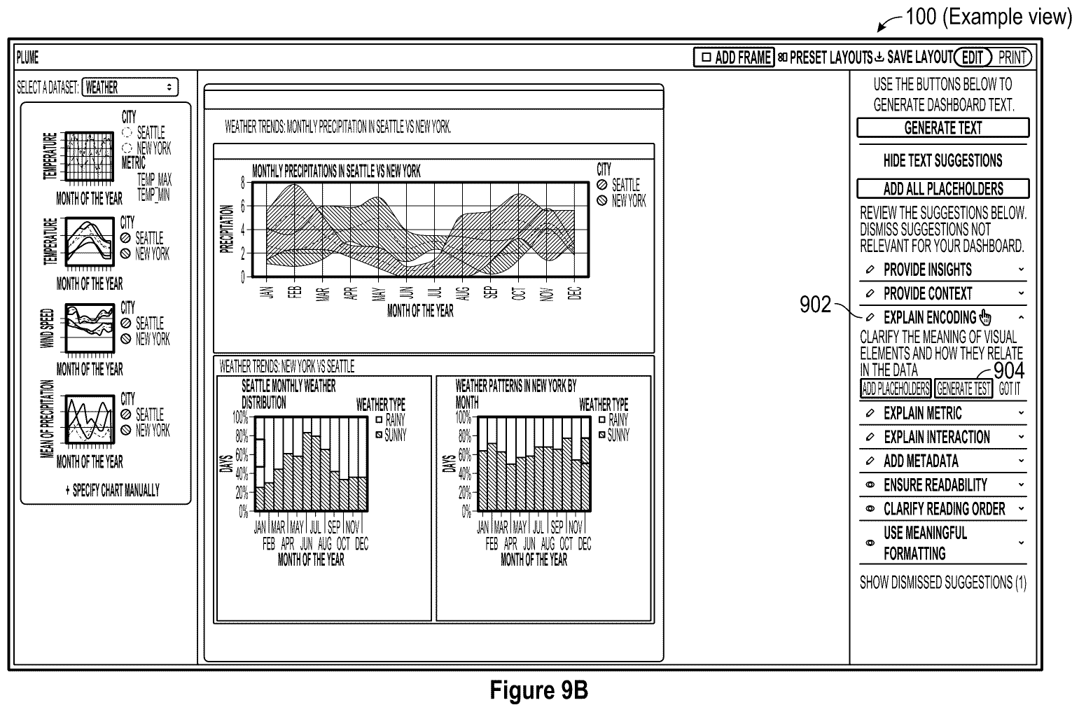

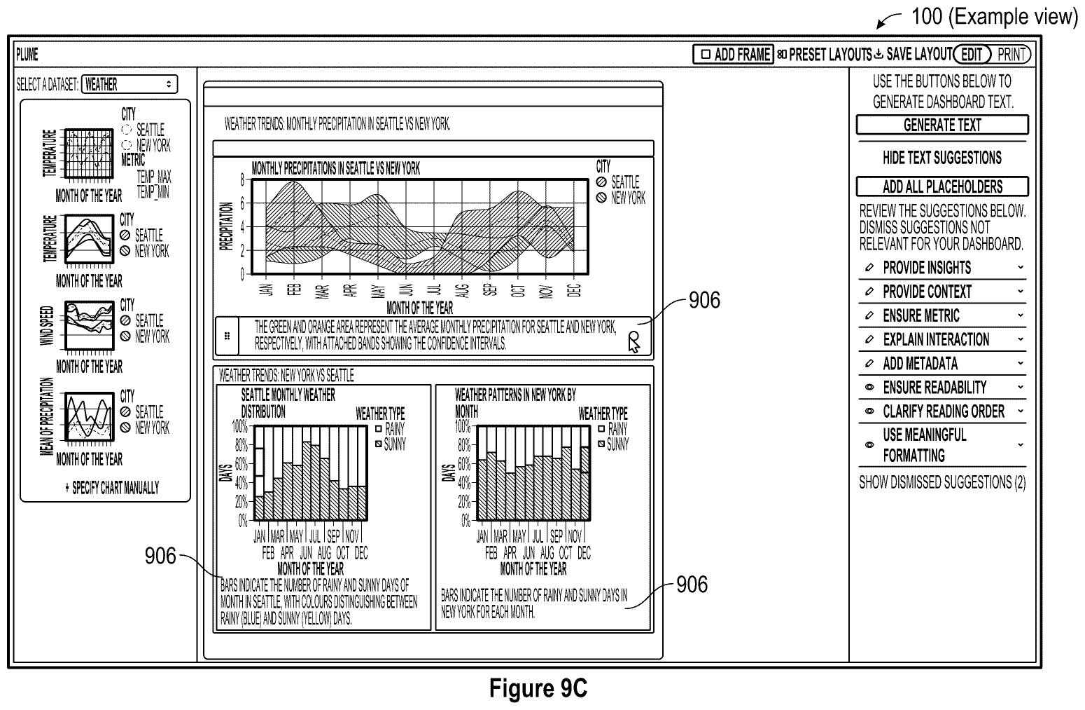

Some implementations leverage the specification of the data underlying the visualizations on canvas to generate the text. Some implementations also use the hierarchy and structure of the sections of the dashboard. The snippet “Weather Trends New York vs. Seattle” for the frame containing two other frames is a summary of their labels, “Seattle Monthly Weather Distribution” and “Weather Patterns in New York by Month” as shown in FIG. 9A. The dashboard title presents the summary of the titles of the two main sections of the dashboard.

In FIG. 9B, the user chooses “Explain encoding”, 902, to add guidance text for the dashboard. Some implementations recognize the frames containing visualizations as the important frames to generate guidance text for. The user chooses Generate text button 904 which generates the text 906 and places it appropriately in each frame as shown in FIG. 9C.

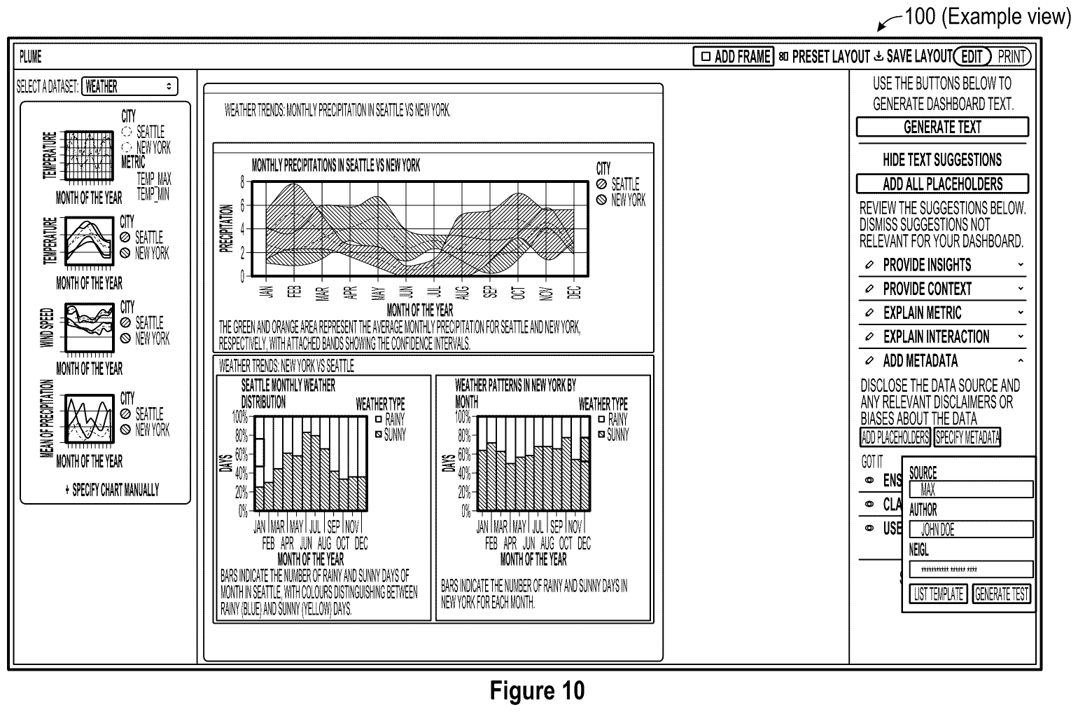

Some types of data such as metadata is not inferred from the dashboard visualizations. Some implementations allow the user to enter metadata as shown in FIG. 10. The user enters source, authorship information, and any disclaimers about the data the user wants to communicate.

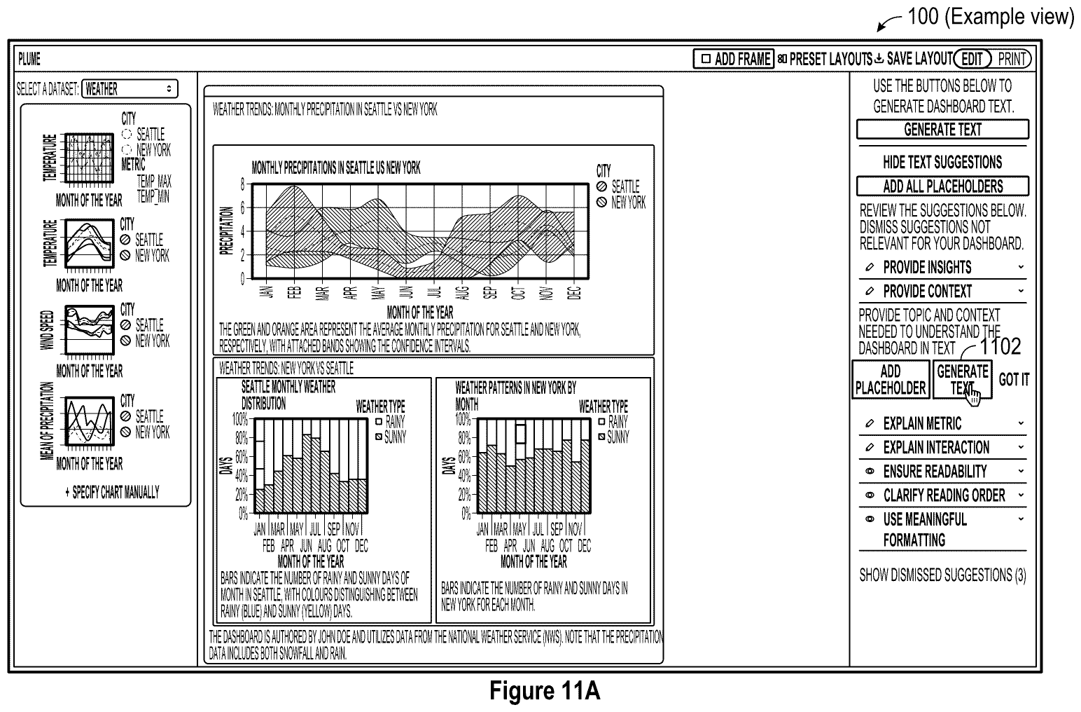

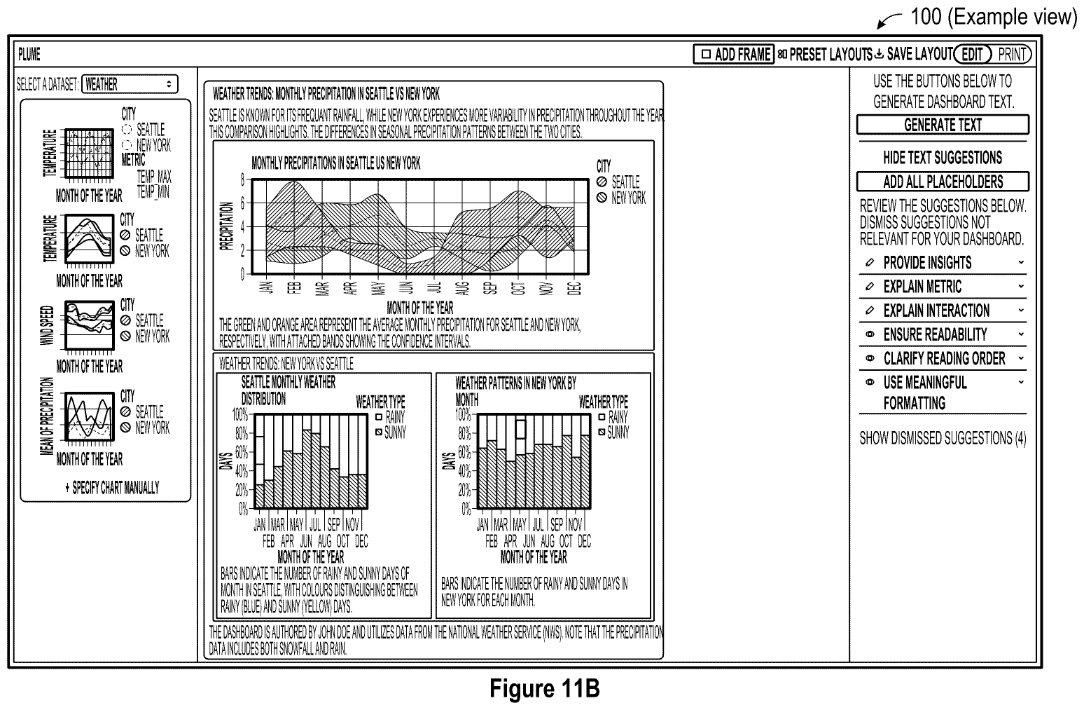

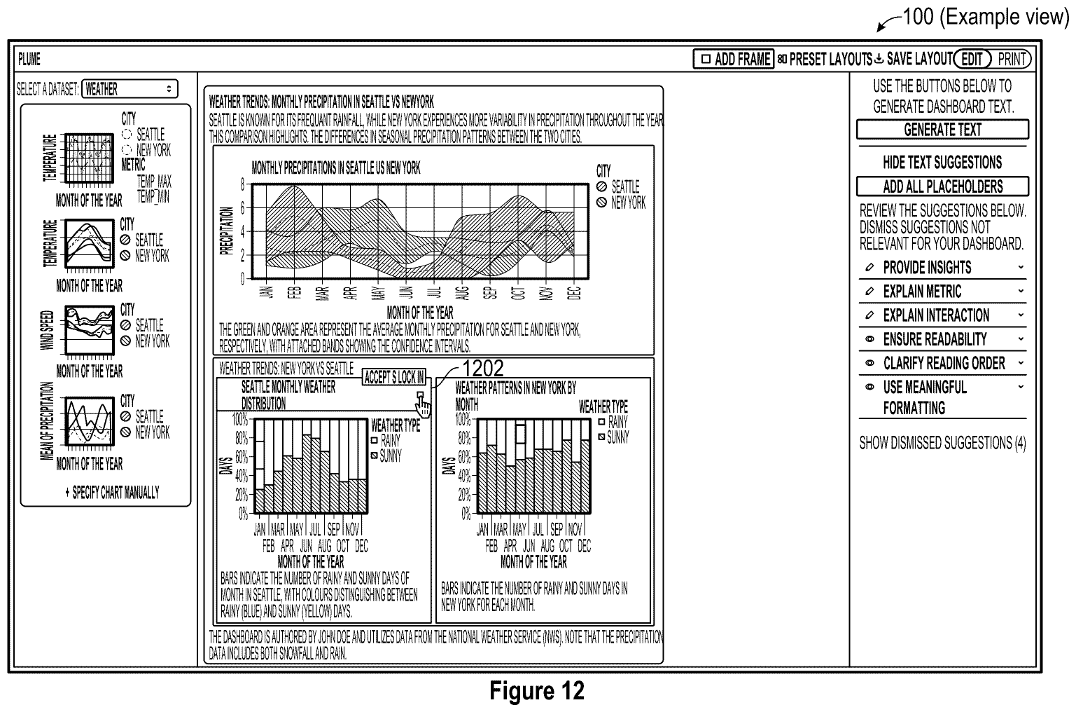

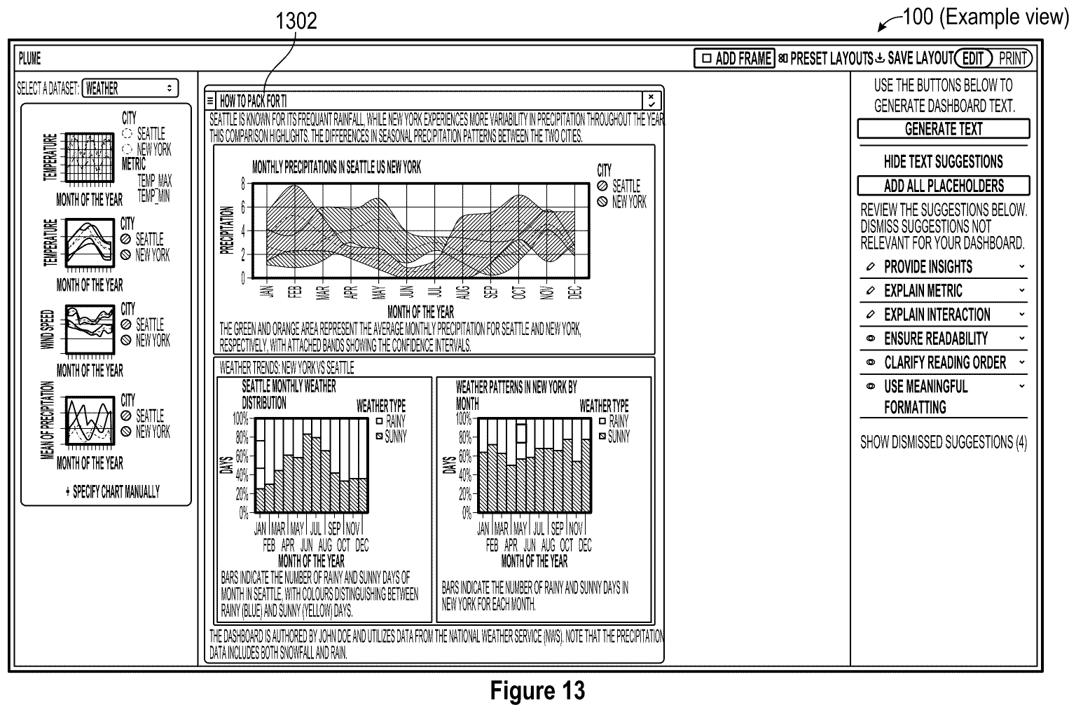

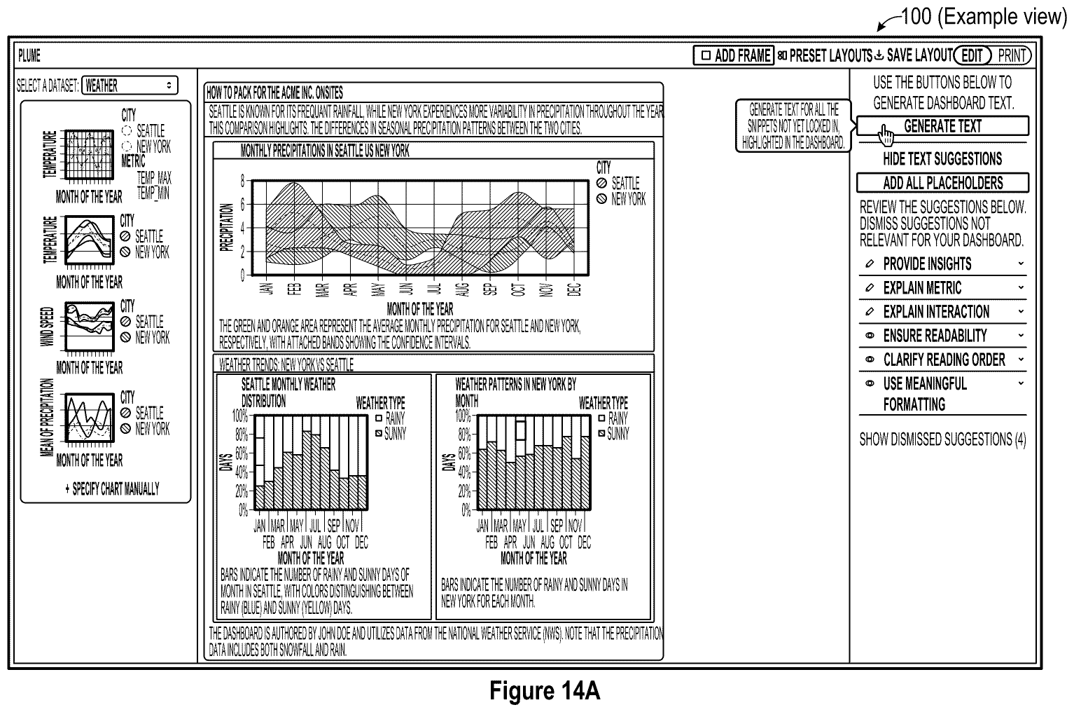

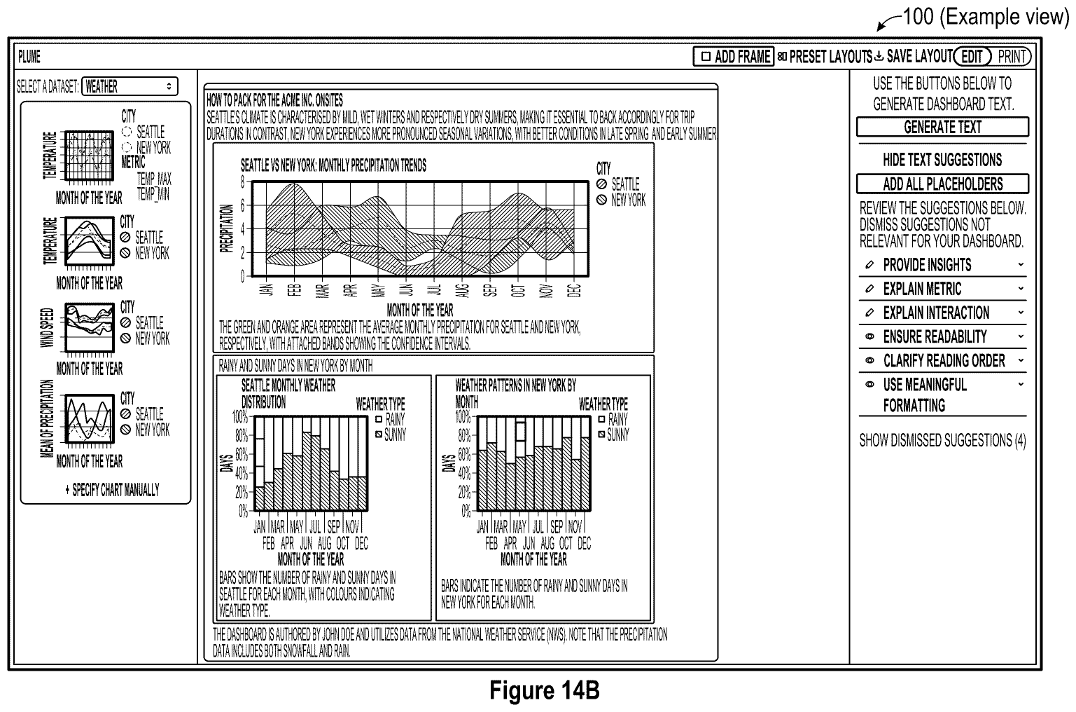

Referring next to FIG. 11A, suppose the user chooses affordance 1102 for some implementations to generate text to provide context for the dashboard data explaining to a data consumer why the data is important or interesting. FIG. 11B shows the text providing context for the dashboard data is automatically generated and placed under the labels. In some implementations, the text provided is grayed out and needs user approval. Further suppose the user accepts and locks in the text by clicking the circle 1202 next to each text as shown in FIG. 12. The user may modify the text by double clicking the circle, editing the text in a text box 1302, and locking it in as shown in FIG. 13. Locked in text is considered for new text generations. As shown in FIG. 14A, suppose the user clicks the Generate text button again to regenerate existing labels that are not locked. FIG. 14B shows newly regenerated text that matches the packing guide title better.

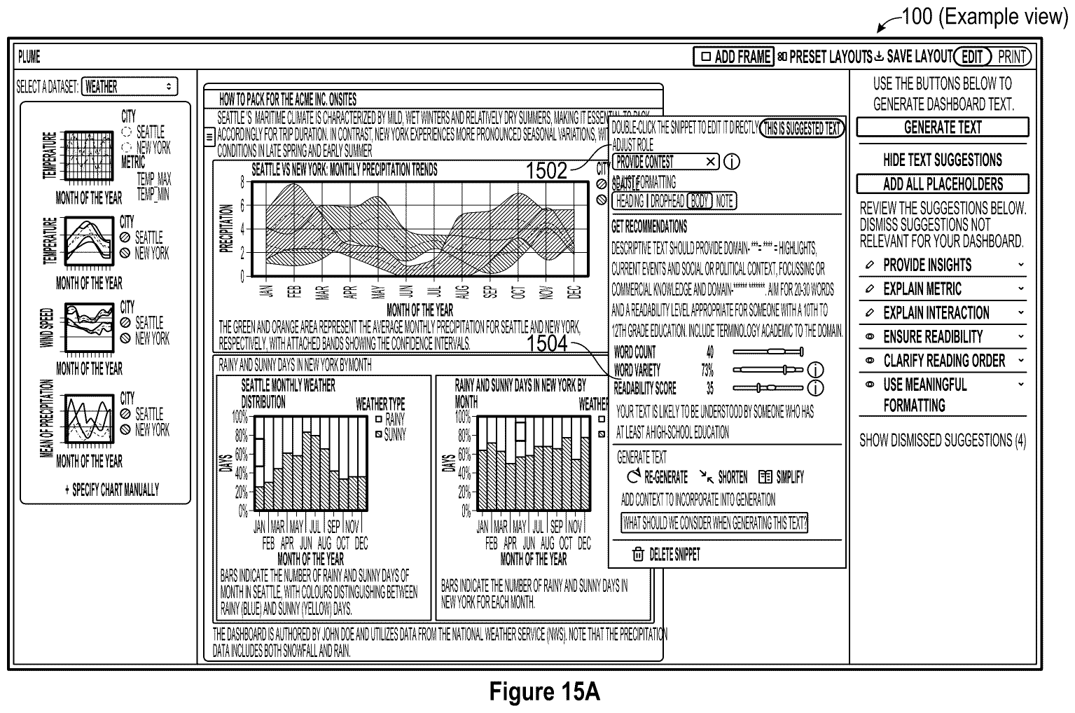

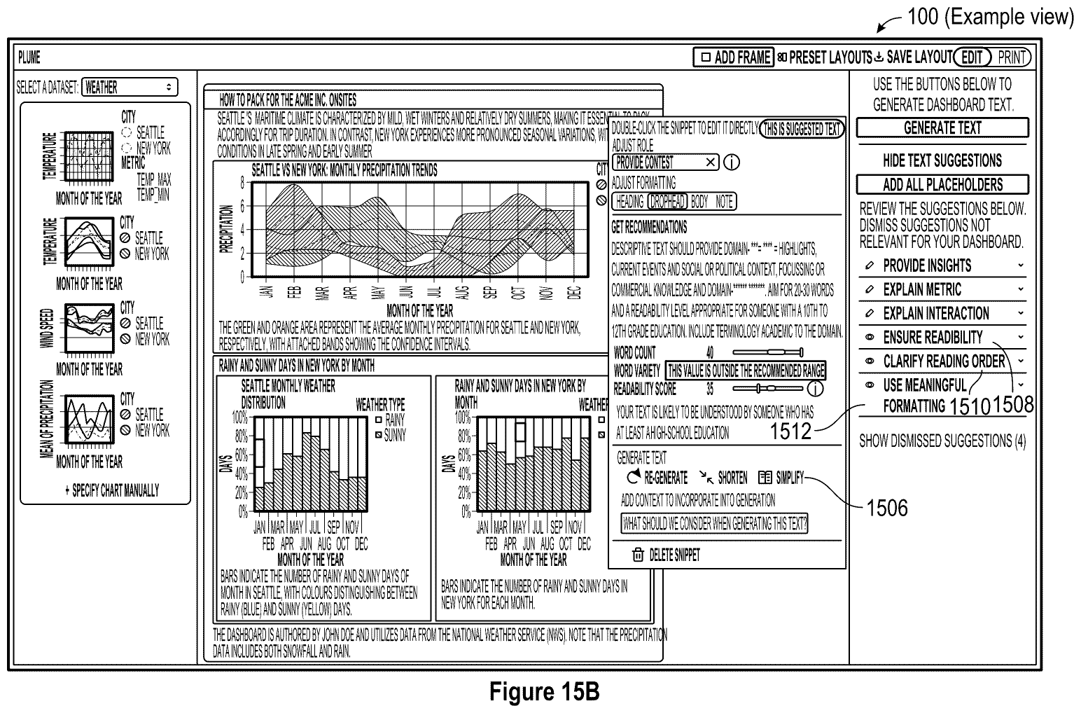

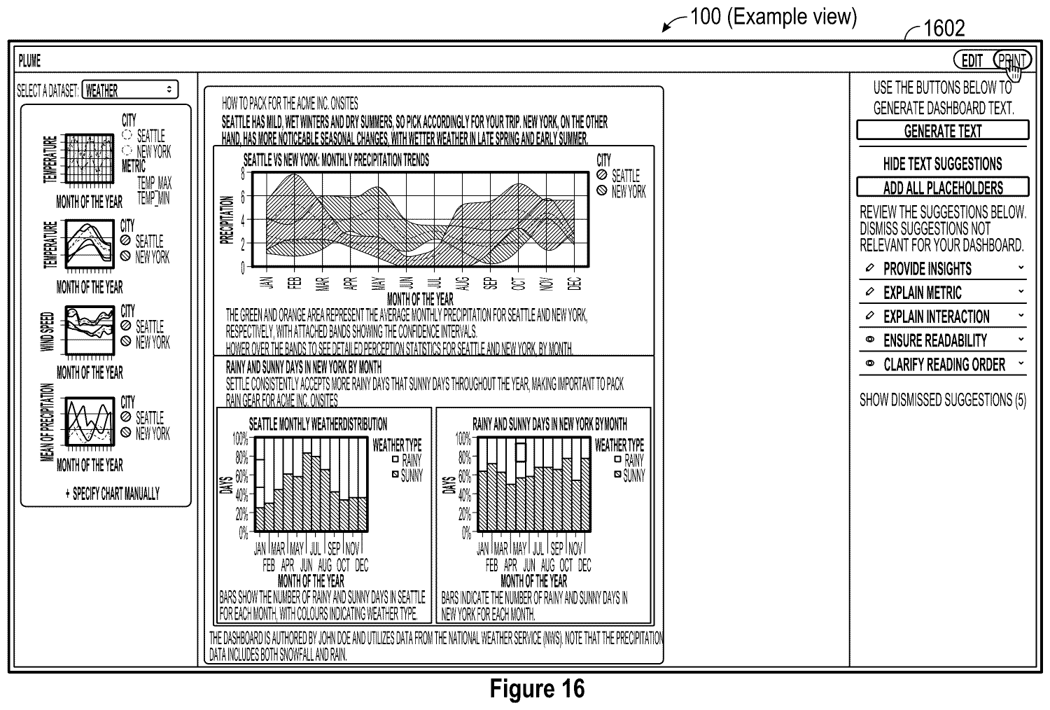

Some implementations provide snippet level granular control, an example of which is shown in FIG. 15A. The user clicks into the snippet and opens up the controls. The user can control the role 1502 that the text plays in the dashboard, its formatting or how prominent it appears. Based on the role, some implementations provide appropriate recommendations for how to write effective dashboard snippets and surface text metrics 1504 for how easy or difficult it would be for the audience to read the text. FIG. 15B shows the user noticing the Readability score is outside the recommended range, The user can click on the Simplify affordance 1506 to simplify the language. Some implementations provide the user with recommendations on readability 1508, clarity for reading order 1510, and to use meaningful formatting 1512. Each pull down opens up to appropriate suggestions for the user. FIG. 16 shows an option 1602 for the user to cause the system to enter a print preview mode, which can disable controls and interactions and the user can view the dashboard.

Example Computing Device for Generating and/or Displaying Data Visualizations

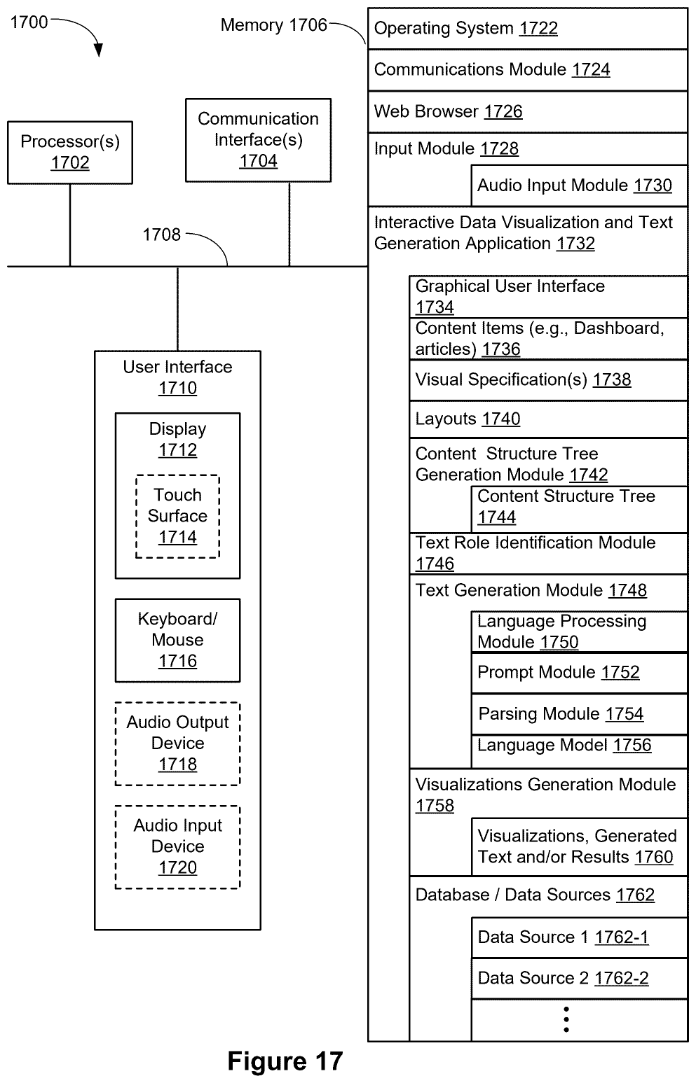

FIG. 17 is a block diagram of an example computing device 1700 for generating and/or displaying interactive data visualizations and textual content, according to some implementations. In some implementations, the computing device 1700 displays a graphical user interface (e.g., the graphical user interfaces 100, 200, 300). Computing devices 1700 include desktop computers, laptop computers, tablet computers, and other computing devices with a display and a processor capable of running a data visualization application. A computing device 1700 typically includes one or more processing units/cores (CPUs) 1702 for executing modules, programs, and/or instructions stored in the memory 1706 and thereby performing processing operations; one or more network or other communications interfaces 1704; memory 1706; and one or more communication buses 1708 for interconnecting these components. The communication buses 1708 may include circuitry that interconnects and controls communications between system components. A computing device 1700 includes a user interface 1710 comprising a display 1712 and one or more input devices or mechanisms 1710. In some implementations, the input device/mechanism includes a keyboard 1716. In some implementations, the input device/mechanism includes a “soft” keyboard, which is displayed as needed on the display 1712, enabling a user to “press keys” that appear on the display 1708. In some implementations, the display 1712 and input device/mechanism comprise a touch screen display 1714 (also called a touch sensitive display). In some implementations, the display is an integrated part of the computing device 1700. In some implementations, the display is a separate display device. Some implementations include an audio input device 1720 and/or an audio output device 1718. The input devices or mechanisms can be used to provide natural language commands directed to data sources.

In some implementations, the memory 1706 includes high-speed random-access memory, such as DRAM, SRAM, DDR RAM or other random-access solid-state memory devices. In some implementations, the memory 1706 includes non-volatile memory, such as one or more magnetic disk storage devices, optical disk storage devices, flash memory devices, or other non-volatile solid-state storage devices. In some implementations, the memory 1706 includes one or more storage devices remotely located from the processors 1702. The memory 1706, or alternatively the non-volatile memory devices within the memory 1706, comprises a non-transitory computer-readable storage medium. In some implementations, the memory 1706, or the computer-readable storage medium of the memory 1706, stores the following programs, modules, and data structures, or a subset thereof:
an operating system 1722, which includes procedures for handling various basic system services and for performing hardware dependent tasks;
a communication module 1724, which is used for connecting the computing device 1700 to other computers and devices via the one or more communication network interfaces 1704 (wired or wireless) and one or more communication networks, such as the Internet, other wide area networks, local area networks, metropolitan area networks, and so on;
an optional web browser 1726 (or other client application), which enables a user to communicate over a network with remote computers or devices;
an input module 1728, which may include an optional audio input module 1730, to process input and/or signals received from the display 1712, the keyboard/mouse 1716, and/or the audio input device 1720, and/or output signals to the output devices (e.g., the audio output device 1718);
an interactive data visualization and/or text generation application 1732, which provides a graphical user interface 1734 for a user to construct visual graphics (e.g., an individual data visualization, a dashboard with a plurality of related data visualizations, and/or textual content). In some implementations, the application 1732 executes as a standalone application (e.g., a desktop application). In some implementations, the application 1732 executes within the web browser 1726 (e.g., as a web application);
a graphical user interface 1734, which enables a user to build data visualization(s), dashboard(s), and/or textual content, by specifying elements visually, audio-visually, and/or via any of the input mechanism described herein. In some implementations, the user interface 1734 includes a plurality of regions or sections, which are used to specify characteristics of a desired data visualization. In some implementations, the regions include a columns shelf and a rows shelf (e.g., for building a data visualization), which are used to specify the arrangement of data in the desired data visualization. In general, fields that are placed on the columns shelf are used to define the columns in the data visualization (e.g., the x-coordinates of visual marks). Similarly, the fields placed on the rows shelf define the rows in the data visualization (e.g., the y-coordinates of the visual marks). In some implementations, the shelf regions include a filters shelf, which enables a user to limit the data viewed according to a selected data field (e.g., limit the data to rows for which a certain field has a specific value or has values in a specific range). In some implementations, the shelf regions include a marks shelf, which is used to specify various encodings of data marks. In some implementations, the marks shelf includes a color encoding icon (to specify colors of data marks based on a data field), a size encoding icon (to specify the size of data marks based on a data field), a text encoding icon (to specify labels associated with data marks), and/or a view level detail icon (to specify or modify the level of detail for the data visualization). Different sections may be used to place data visualizations for creating a dashboard, and/or for preparing an article, such as a newspaper article;
content items 1736 can include dashboards and/or articles (e.g., newspaper articles, magazine articles);
visual specifications 1738, which are used to define characteristics of a desired data visualization. In some implementations, the visual specifications 1738 is built using the user interface 1734. A visual specification includes identified data sources 1762 (i.e., specifies what the data sources are), which provide enough information to find the data sources 1762 (e.g., a data source name or network full path name). A visual specification 1738 also includes visual variables, and the assigned data fields for each of the visual variables. In some implementations, a visual specification has visual variables corresponding to each of the shelf regions. In some implementations, the visual variables include other information as well, such as context information about the computing device 1700, user preference information, or other data visualization features that are not implemented as shelf regions (e.g., analytic features);
layouts 1740, which may include an organization of a dashboard or an article (e.g., how the dashboard is split into different sections or regions, orientations, shape, size, relative positions for sections, and so on);
a content tree structure generation module 1742 for generating content structure tree 1744;
a text role identification module 1746 for identifying roles of texts generated for and/or identified in the content items 1736;
a text generation module 1748 for generating texts for the content items 1736, which can include a language processing module 1750, a prompt module 1752, a parsing module 1754, and/or a language model 1756;
a visualization generation module 1758, which generates visualizations, text and/or results 1746 based on results from other modules of the application 1732; and/or
zero or more databases or data sources 1762 (e.g., a first data source 1762-1), which are used by the application 1732. In some implementations, the data sources are stored as spreadsheet files, CSV files, XML files, flat files, JSON files, tables in a relational database, cloud databases, or statistical databases.

The language processing module 1750 parses natural language utterances (sometimes referred to as commands or natural language queries) directed to the data sources 1762. In some implementations, the language processing module 1750 includes semantic search for understanding conceptual meaning of a query by analyzing relations between words, phrases and/or concepts in the natural language query. This may include natural language processing (NLP) techniques to analyze the structure and meaning of the query, including part-of-speech tagging, named entity recognition and/or sentiment analysis, sentiment analysis for identifying key concepts, entities and relationships present in the query and the content, e.g., using knowledge bases, ontologies and/or taxonomies.

The prompt module 1752 generates prompts for large language models. This module may include NLP model trained to understand natural language descriptions or instructions and convert them into structured prompts suitable for LLMs. Some implementations include optimization(s) to select the suitable prompt based on criteria such as performance metrics, user preferences and/or domain specific characteristics (e.g., for data visualization specification generation). The prompt module 1752 generates prompts based on relevant data fields and data values, and/or rules for generating textual content, details of which are described below. The prompt module 1752 also prompts the trained large language model 1756 using the prompts to generate a structured document following a domain-specific schema based on a shorthand notation, details of which are described below, according to some implementations. The prompt module 1752 also stores any data structures (e.g., rules) for performing the operations described herein.

The parsing module 1754 parses (e.g., performs grid-based parsing) to identify spatial arrangement elements. The parsing module 1754 can also include conventional parsing techniques or algorithms, and/or use grammar rules (e.g., context free grammars) for parsing textual content. In some implementations, the visual specification specifies a data source, a plurality of visual variables, and a plurality of data fields from the data source. The language model 1756 includes one or more large language models (LLMs) that are trained to generate structured documents and/or text. In some implementations, the large language models are finetuned using visual specifications and/or textual content generated for dashboards, data visualizations and/or articles.

In addition to the modules and/or data structures described above, the memory 1706 stores additional modules and data structures that may be necessary for performing the operations described in reference to FIGS. 1-16, and FIG. 18, even if not explicitly described herein. Each of the above identified executable modules, applications, or set of procedures may be stored in any of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various implementations. In some implementations, the memory 1706 stores a subset of the modules and data structures identified above. In some implementations, the memory 1706 stores additional modules or data structures not described above. Although FIG. 17 shows a computing device 1700, FIG. 17 is intended more as a functional description of the various features that may be present rather than as a structural schematic of the implementations described herein. In practice, and as recognized by those of ordinary skill in the art, items shown separately could be combined and some items could be separated.

The language models 1756 can include Application Programming Interfaces (APIs) to large language models, which can reside in remote computers connected to the computing device 1700. Smaller inference models can be resident on the computing device 1700 (e.g., may be used for inference without remote access). Large Language Models (LLMs) can be used to generate structured data in formats, such as JSON, YAML, and XML. These formats are widely used for structuring data due to their versatility and compatibility across different systems. The trained LLMs may include pre-trained models, such as GPT-4, which may be further fine-tuned for the purpose of generating visualization specifications and/or shorthand notations described herein. Large Language Models (LLMs) can be trained on a variety of data formats, including JSON and Python code, to generate structured documents. In some implementations, for training such models, a first step includes collecting a large dataset of JSON files or Python code that represent the desired structure of the output documents or textual content (e.g., headlines, insights). This dataset is diverse and representative of the types of documents (e.g., textual content) to generate. The data may be preprocessed. The raw data may need to be preprocessed to prepare it for training. This can involve tasks like cleaning the data, removing irrelevant parts, tokenizing the text, and converting it into a format suitable for the LLM's input. Subsequently, in some implementations, the model is trained using the preprocessed data for a language modeling task. The model is trained to take the input (e.g., a prompt or description) and generate the corresponding structured output (e.g., JSON or Python code, textual content).

The trained LLMs can include pre-trained models, such as GPT-4, which may be further fine-tuned for the purpose of generating text for dashboards, articles, and/or data visualizations, described herein. Large Language Models (LLMs) can be trained on a variety of data formats, including JSON and Python code, to generate structured documents. In some implementations, for training such models, a first step includes collecting a large dataset of JSON files or Python code that represent the desired structure of the output documents. This dataset is diverse and representative of the types of documents (e.g., visual specifications, text) to generate. The data may be preprocessed. The raw data may need to be preprocessed to prepare it for training. This can involve tasks like cleaning the data, removing irrelevant parts, tokenizing the text, and converting it into a format suitable for the LLM's input. Subsequently, in some implementations, the model is trained using the preprocessed data for a language modeling task. The model is trained to take the input (e.g., a prompt or description) and generate the corresponding structured output (e.g., JSON or Python code).

The trained language model can be fine-tuned. Depending on the complexity of the task and the size of the dataset, the LLM can be fine-tuned on the specific domain and data format. Fine-tuning involves further training the model on a target dataset to adapt it to the task at hand. For generating data visualization specification, the trained language model can be fine-tuned for specific visualization specifications for data visualizations. After the model is trained, the trained model can be used to generate structured documents based on new prompts or inputs. The model can output the corresponding JSON or Python code and/or textual content, for example, which can then be displayed, parsed and/or processed as needed. In some implementations, the training data and/or target data for finetuning is formatted in a way that preserves the structure of the JSON or Python code or textual content, for example, allowing the model to learn the patterns and relationships within the data. Appropriate evaluation metrics, such as BLEU score, perplexity, or task-specific metrics, can be used to measure the model's performance and guide the training.

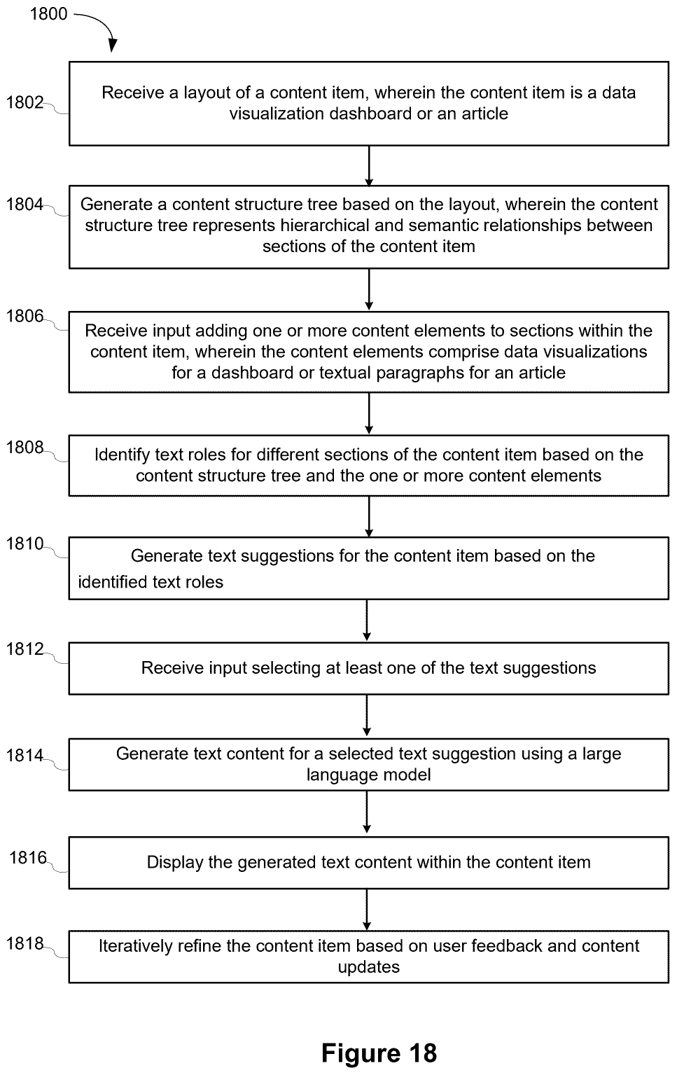

FIG. 18 is a flowchart of an example method 1800 for generating dashboard text, according to some implementations. The method is performed at a computing device (e.g., the computing device 1700) having one or more processors (e.g., the processors 1702), and memory (e.g., the memory 1706) storing one or more programs configured for execution by the one or more processors.

The method includes receiving (1802, e.g., by the input module 1728) a layout of a content item, such as a data visualization dashboard or an article.

The method also includes generating (1804, e.g., by the content structure tree generation module 1742) a content structure tree based on the layout. The content structure tree represents hierarchical and semantic relationships between sections of the content item. In some implementations, generating the content structure tree includes identifying parent-child relationships between content sections based on structural nesting and semantic relationships in the layout, assigning a hierarchical level to each identified section, and creating nodes in the content structure tree corresponding to each section, with edges representing the identified relationships. In some implementations, generating the content structure tree includes performing grid-based parsing of the layout to identify spatial arrangement of elements, analyzing proximity and containment relationships between the elements to determine parent-child relationships, performing semantic analysis to classify each element based on its type and role in the content item, assigning roles to text elements based on their relationship with visual components, establishing hierarchical dependencies between nodes based on spatial and semantic analysis, and dynamically updating the content structure tree in response to user changes to the layout. In some implementations, the content structure tree is generated based on user input defining the layout, importing a pre-authored template or existing content item, or a combination of user authoring and pre-defined templates.

The method also includes receiving input (1806, e.g., by the graphical user interface 1734) adding one or more content elements to sections within the content item. The content elements may include data visualizations for a dashboard or textual paragraphs for an article.

The method also includes identifying text roles (1808, e.g., by the text role identification module 1746) for different sections of the content item based on the content structure tree and the one or more content elements. The method also includes generating text suggestions (1810, e.g., the text generation module 1748) for the content item based on the identified text roles. In some implementations, identifying text roles and generating text suggestions includes analyzing the content structure tree to identify appropriate locations for different text roles, examining specifications and data of content elements within each section, to identify content type for each content element, and determining appropriate text roles for each content element based on (i) the content type, (ii) position of the content element in the content structure tree, and (iii) comparing a current structure for the content element to predefined templates and best practices. In some implementations, the text roles include at least one of: context, insight, data label, interaction explanation, metadata, metric explanation, summary, or visualization encoding explanation.

The method also includes receiving input selecting (1812, e.g., by the graphical user interface 1734) at least one of the text suggestions.

The method also includes generating text content (1814, e.g., by the text generation module 1748) for a selected text suggestion using a large language model. In some implementations, generating text content using the large language model includes identifying relevant context for the selected text suggestion based on its position in the content structure tree and its text role, retrieving specifications of related content elements, including data types, encodings, key topics, and named entities, incorporating any user-entered text in the content item, selecting similar text from a database of exemplary content items based on structural and content similarity, and inputting the identified context, specifications, user-entered text, and similar text as a prompt to the large language model to obtain the text content.

The method also includes displaying the generated text content (1816, e.g., by the graphical user interface 1734) within the content item.

The method also includes iteratively refining (1818, e.g., by the text generation module 1748) the content item based on user feedback and content updates. In some implementations, iteratively refining the content item includes monitoring user interactions with the content item, detecting changes in underlying data or textual content for the content item, updating the content structure tree in response to user modifications to the layout, regenerating text content based on the updated content structure tree and content changes, and dynamically adjusting text placement and roles within the content item to maintain semantic coherence with the updated content structure tree and content.

In some implementations, the method further includes enforcing an asynchronous order of text generation based on the content structure tree. The text in leaf sections of the content structure tree is generated before text in parent sections, and text in a parent section summarizes or compares text from its child sections.

In some implementations, the method further includes maintaining semantic coherence by analyzing relationships between text elements across different levels of hierarchy of the content tree structure, ensuring consistency in terminology, tone, and narrative flow, adjusting generated text to align with user-defined content objectives and inferred intent, based on analysis of locked-in text, and resolving conflicts between automatically generated text and user-entered content.

In some implementations, the method further includes providing snippet-level guidance for user-entered text, including recommendations for writing text based on the identified text role, text metrics including at least one of word count, word variety, or readability score, and options to regenerate, shorten, simplify, or modify text style using the large language model.

In some implementations, the method further includes analyzing the semantics of the data or textual content, including trends, key topics, and named entities, and incorporating semantic analysis into text generation process to provide insights or summaries.

In some implementations, the method further includes analyzing user interactions to identify areas of user interest or confusion by tracking user engagement patterns, including tracking frequency and duration of user interactions with specific dashboard elements, identifying sections of the content item with high or low engagement, detecting repeated interactions that may indicate confusion, comparing interaction patterns against expected flows based on the content structure tree, and generating targeted suggestions for improving clarity or usability based on the areas of user interest or confusion.

In some implementations, the method further includes monitoring changes in underlying data or textual content, automatically updating the generated text content when significant changes are detected, and providing one or more alerts to the user when automatic updates affect an overall narrative or message of the content item.

In some implementations, significant changes are determined by calculating statistical measures of change in key metrics or content, identifying shifts in trends, patterns, or key topics, detecting appearance or disappearance of important data categories or named entities, and comparing changes against predefined thresholds specific to the content type.

In some implementations, the one or more alerts is selected from the group consisting of notifications of newly emerging trends or topics that contradict previous insights, warnings about significant changes in key metrics or facts highlighted in summaries, suggestions to review and potentially update high-level conclusions or headlines, and indications of sections where generated text no longer accurately reflect the updated content.

In some implementations, providing the one or more alerts includes categorizing significance of detected changes based on their potential impact on key insights or conclusions, generating different levels of alerts based on the categorized significance, providing interactive previews of how the changes might affect a dashboard's narrative, providing options to accept, modify, or reject suggested updates, and maintaining a log of significant changes and user decisions for future reference and analysis.

In some implementations, the method further includes using locked-in text to infer content intent and tone, by (i) analyzing the content and style of user-entered text, (ii) identifying key themes, terminology, and narrative elements, and (iii) extracting sentiment and formality levels, and using the inferred content intent and tone to guide the generation of new text content.

In some implementations, using locked-in text to infer content intent and tone further includes performing linguistic analysis on the locked-in text to identify key phrases, sentiments, and writing style, creating a user intent profile based on comparing the identified key phrases, sentiments, and writing style with a database of industry-specific communication styles, and using the user intent profile to guide the generation and refinement of new text content across the dashboard.

In some implementations, the method further includes providing real-time feedback on content readability and coherence by calculating readability scores for individual text elements and the content item as a whole, analyzing logical flow of information across content sections, identifying potential inconsistencies or contradictions in presented data, facts, or arguments and evaluating balance of different content elements, and suggesting improvements based on the readability scores, the logical flow, the potential inconsistencies or contradictions, and best practices for the content type and identified text roles, to improve readability while maintaining intended message and tone.

In some implementations, providing real-time feedback on content readability and coherence further includes calculating Flesch-Kincaid readability score for the individual text elements and the content item as a whole, comparing the calculated scores against predefined thresholds based on intended audience, monitoring word variety for the individual text elements and the content item as a whole, to avoid redundancy and maintain engagement, determining appropriate word count for the individual text elements and the content item as a whole, based on text role, analyzing the logical flow between text elements to ensure alignment with overall narrative structure, and considering the hierarchical relationships within the dashboard to maintain consistent tone and intent across different sections.

In some implementations, the method further includes matching a current structure of a content against a library of predefined templates and exemplary dashboards for type of the respective content type, identifying potential improvements in layout, content organization, or narrative flow, suggesting additions of commonly used elements that are currently missing, and providing guidance on industry-specific best practices relevant to the content's purpose and audience.

In some implementations, the method further includes maintaining a database of exemplary dashboards curated from industry best practices, analyzing a current dashboard layout and content to identify its primary purpose and industry context, selecting relevant exemplary dashboards based on the identified purpose and context, comparing the current dashboard against the selected exemplary dashboards to identify potential improvements, and generating suggestions for enhancements in layout, content organization, and narrative flow based on the comparison.

In some implementations, the method further includes determining missing elements in the dashboard by (i) analyzing the dashboard's layout, content, and relationships between visualizations and text, (ii) identifying gaps where essential text or visual elements may be missing, and (iii) prioritizing suggestions for adding missing elements based on their importance to overall narrative and user comprehension, and providing the suggestions that align with intent to enhance clarity and effectiveness of the dashboard, based on the missing elements.

In some implementations, the method further includes differentiating between structural positioning and text roles in the content structure tree, allowing text to be moved between different sections while maintaining its text role, and updating the text content and context based on the text's new position in the content structure tree when moved.

In some implementations, the method further includes applying custom styling based on text roles, including adjusting font sizes, styles, and colors based on importance and function of each text role, and modifying tone and emphasis to match semantic levels and roles of the text.

In some implementations, the content structure tree is generated based on user input defining the layout, importing a pre-authored template or existing content item, or a combination of user authoring and pre-defined templates.

In some implementations, the method further includes maintaining visual containment relationships by analyzing spatial arrangement and hierarchical structure of dashboard elements, identifying visual and structural cues including proximity, alignment, and grouping of elements, creating visually salient frames that enclose related content, and ensuring that each text and visualization is placed within an appropriate frame to define its scope.

In some implementations, the method further includes determining relevance of text examples for generating text suggestions analyzing role of text to be generated, considering type of visualization and data context, examining specific attributes of data and its visual representation, evaluating position of the text within the dashboard's hierarchical structure, and taking into account user preferences and overall dashboard context.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

1. A computer-implemented method for generating textual content for a data-driven content item, comprising:
receiving a layout of a content item, wherein the content item is a data visualization dashboard or an article;
generating a content structure tree based on the layout, wherein the content structure tree represents hierarchical and semantic relationships between sections of the content item;
receiving input adding one or more content elements to sections within the content item, wherein the content elements comprise data visualizations for a dashboard or textual paragraphs for an article;
identifying text roles for different sections of the content item based on the content structure tree and the one or more content elements;
generating text suggestions for the content item based on the identified text roles;
receiving input selecting at least one of the text suggestions;
generating text content for a selected text suggestion using a large language model;
displaying the generated text content within the content item; and
iteratively refining the content item based on user feedback and content updates.

2. The method of claim 1, wherein generating the content structure tree comprises:
identifying parent-child relationships between content sections based on structural nesting and semantic relationships in the layout;
assigning a hierarchical level to each identified section; and
creating nodes in the content structure tree corresponding to each section, with edges representing the identified relationships.

3. The method of claim 1, wherein generating the content structure tree comprises:
performing grid-based parsing of the layout to identify spatial arrangement of elements;
analyzing proximity and containment relationships between the elements to determine parent-child relationships;
performing semantic analysis to classify each element based on its type and role in the content item;
assigning roles to text elements based on their relationship with visual components;
establishing hierarchical dependencies between nodes based on spatial and semantic analysis; and
dynamically updating the content structure tree in response to user changes to the layout.

4. The method of claim 1, wherein identifying text roles and generating text suggestions comprises:
analyzing the content structure tree to identify appropriate locations for different text roles;
examining specifications and data of content elements within each section, to identify content type for each content element; and
determining appropriate text roles for each content element based on (i) the content type, (ii) position of the content element in the content structure tree, and (iii) comparing a current structure for the content element to predefined templates and best practices.

5. The method of claim 1, wherein the text roles include at least one of:
context, insight, data label, interaction explanation, metadata, metric explanation, or visualization encoding explanation.

6. The method of claim 1, wherein iteratively refining the content item comprises:
monitoring user interactions with the content item;
detecting changes in underlying data or textual content for the content item;
updating the content structure tree in response to user modifications to the layout;
regenerating text content based on the updated content structure tree and content changes; and
dynamically adjusting text placement and roles within the content item to maintain semantic coherence with the updated content structure tree and content.

7. The method of claim 1, wherein generating text content using the large language model comprises:
identifying relevant context for the selected text suggestion based on its position in the content structure tree and its text role;
retrieving specifications of related content elements, including data types, encodings, key topics, and named entities;
incorporating any user-entered text in the content item;
selecting similar text from a database of exemplary content items based on structural and content similarity; and
inputting the identified context, specifications, user-entered text, and similar text as a prompt to the large language model to obtain the text content.

8. The method of claim 1, further comprising enforcing an asynchronous order of text generation based on the content structure tree, wherein text in leaf sections of the content structure tree is generated before text in parent sections, and text in a parent section summarizes or compares text from its child sections.

9. The method of claim 1, further comprising maintaining semantic coherence by:
analyzing relationships between text elements across different levels of hierarchy of the content tree structure;
ensuring consistency in terminology, tone, and narrative flow;
adjusting generated text to align with user-defined content objectives and inferred intent, based on analysis of locked-in text; and
resolving conflicts between automatically generated text and user-entered content.

10. The method of claim 1, further comprising providing snippet-level guidance for user-entered text or refinement of generated text, including recommendations for writing text based on the identified text role, text metrics including at least one of word count, word variety, or readability score, and options to regenerate, shorten, simplify, or modify text style using the large language model.

11. The method of claim 1, further comprising:
analyzing the semantics of the data or textual content, including trends, key topics, and named entities; and
incorporating semantic analysis into the generating text suggestions to provide insights or summaries.

12. The method of claim 1, further comprising:
analyzing user interactions to identify areas of user interest or confusion by:
tracking user engagement patterns, including tracking frequency and duration of user interactions with specific dashboard elements;
identifying sections of the content item with high or low engagement;
detecting repeated interactions that may indicate confusion;
comparing interaction patterns against expected flows based on the content structure tree; and
generating targeted suggestions for improving clarity or usability based on the areas of user interest or confusion.

13. The method of claim 1, further comprising:
monitoring changes in underlying data or textual content;
automatically updating the generated text content when significant changes are detected; and
providing one or more alerts to the user when automatic updates affect an overall narrative or message of the content item.

14. (canceled)

15. (canceled)

16. The method of claim 13, wherein providing the one or more alerts comprises:
categorizing significance of detected changes based on their potential impact on key insights or conclusions;
generating different levels of alerts based on the categorized significance;
providing interactive previews of how the changes might affect a dashboard's narrative;
providing options to accept, modify, or reject suggested updates; and
maintaining a log of significant changes and user decisions for future reference and analysis.

17. The method of claim 1, further comprising:
using locked-in text to infer content intent and tone, by (i) analyzing the content and style of user-entered text, (ii) identifying key themes, terminology, and narrative elements, and (iii) extracting sentiment and formality levels; and
using the inferred content intent and tone to guide the generation of new text content.

18. The method of claim 17, wherein using locked-in text to infer content intent and tone further comprises:
performing linguistic analysis on the locked-in text to identify key phrases, sentiments, and writing style;
creating a user intent profile based on comparing the identified key phrases, sentiments, and writing style with a database of industry-specific communication styles; and
using the user intent profile to guide the generation and refinement of new text content across the dashboard.

19. The method of claim 1, further comprising providing real-time feedback on content readability and coherence by:
calculating readability scores for individual text elements and the content item as a whole;
analyzing logical flow of information across content sections;
identifying potential inconsistencies or contradictions in presented data, facts, or arguments and evaluating balance of different content elements; and
suggesting improvements based on the readability scores, the logical flow, the potential inconsistencies or contradictions, and best practices for the content type and identified text roles, to improve readability while maintaining intended message and tone.

20. The method of claim 19, wherein providing real-time feedback on content readability and coherence further comprises:
calculating Flesch-Kincaid readability score for the individual text elements and the content item as a whole;
comparing the calculated scores against predefined thresholds based on intended audience;
monitoring word variety for the individual text elements and the content item as a whole, to avoid redundancy and maintain engagement;
determining appropriate word count for the individual text elements and the content item as a whole, based on text role;
analyzing the logical flow between text elements to ensure alignment with overall narrative structure; and
considering the hierarchical relationships within the dashboard to maintain consistent tone and intent across different sections.

21. (canceled)

22. (canceled)

23. (canceled)

24. (canceled)

25. (canceled)

26. (canceled)

27. (canceled)

28. (canceled)

29. A computer system for generating interactive data visualizations and textual content, comprising:
one or more processors; and
memory;
wherein the memory stores one or more programs configured for execution by the one or more processors, and the one or more programs comprising instructions for:
receiving a layout of a content item, wherein the content item is a data visualization dashboard or an article;
generating a content structure tree based on the layout, wherein the content structure tree represents hierarchical and semantic relationships between sections of the content item;
receiving input adding one or more content elements to sections within the content item, wherein the content elements comprise data visualizations for a dashboard or textual paragraphs for an article;
identifying text roles for different sections of the content item based on the content structure tree and the one or more content elements;
generating text suggestions for the content item based on the identified text roles;
receiving input selecting at least one of the text suggestions;
generating text content for a selected text suggestion using a large language model;
displaying the generated text content within the content item; and
iteratively refining the content item based on user feedback and content updates.

30. A non-transitory computer readable storage medium storing one or more programs configured for execution by a computer system having a display, one or more processors, and memory, the one or more programs comprising instructions for:
receiving a layout of a content item, wherein the content item is a data visualization dashboard or an article;
generating a content structure tree based on the layout, wherein the content structure tree represents hierarchical and semantic relationships between sections of the content item;
receiving input adding one or more content elements to sections within the content item, wherein the content elements comprise data visualizations for a dashboard or textual paragraphs for an article;
identifying text roles for different sections of the content item based on the content structure tree and the one or more content elements;
generating text suggestions for the content item based on the identified text roles;
receiving input selecting at least one of the text suggestions;
generating text content for a selected text suggestion using a large language model;
displaying the generated text content within the content item; and
iteratively refining the content item based on user feedback and content updates.
